(19) United States
(12) Patent Application Publication
(10) Pub. No.: US 2025/0269385 A1
(43) Pub. Date: Aug. 28, 2025

(54) METHOD FOR TREATMENT OF ORE USING CARBON DIOXIDE

(71) Applicant: VIRGINIA TECH INTELLECTUAL PROPERTIES, INC., Blacksburg, VA (US)

(72) Inventors: Wencai ZHANG, Blacksburg, VA (US); Xu WANG, Blacksburg, VA (US)

(21) Appl. No.: 19/059,876

(22) Filed: Feb. 21, 2025

Related U.S. Application Data
(60) Provisional application No. 63/556,987, filed on Feb. 23, 2024.

(51) Int. Cl. B02C 23/18; B01D 53/62; B01D 53/80; B02C 23/06

(52) U.S. Cl. CPC B02C 23/18; B01D 53/62; B01D 53/80; B02C 23/06; B01D 2251/402; B01D 2251/404; B01D 2257/504

(57) ABSTRACT

In one aspect, the disclosure relates to methods for treating a slurry with CO₂, where the slurry comprises water and an ore sample. This abstract is intended as a scanning tool for purposes of searching in the particular art and is not intended to be limiting of the present disclosure.

### CROSS-REFERENCE TO RELATED APPLICATIONS

This Application claims the benefit of and priority to U.S. Provisional Application No. 63/556,987, filed on Feb. 23, 2024, which is incorporated herein by reference in its entirety.

### STATEMENT ON FUNDING PROVIDED BY THE U.S. GOVERNMENT

This invention was made with Government support under contract DE-AR0001713 awarded by the Department of Energy. The Government has certain rights in the invention.

### BACKGROUND

Beneficiation is a method for extracting valuable metal and non-metallic elements from ores. It mainly separates the target minerals from gangue minerals based on the differences in their physical and chemical properties, using methods such as flotation, gravity separation, magnetic separation, and electrostatic separation. This provides qualified raw materials for subsequent metallurgical and material processing.

Grinding is an important preparation operation for the beneficiation. By liberating the target mineral from the ore through grinding, separation of the target mineral from the gangue ore can be achieved. However, grinding is an extremely energy-intensive process, accounting for approximately 4% of the world's total energy consumption and more than 40% of the total energy consumption of the entire beneficiation process. Reducing the energy consumption in grinding not only lowers the extraction cost of valuable minerals, enhancing the economic efficiency of mining companies, but also reduces carbon emissions and other environmental pollution, contributing to the sustainable development of the mining industry.

Developing new grinding equipment, optimizing grinding parameters, and adding grinding aids are commonly employed to enhance grinding efficiency. However, the improvement in grinding efficiency through equipment and parameter optimization has reached a bottleneck after extensive research. Additionally, the addition of grinding aids poses potential environmental risks, increases costs, and may have adverse effects on subsequent mineral processing. Therefore, a green and efficient process to improve grinding efficiency is needed.

### SUMMARY

In accordance with the purpose(s) of the disclosure, as embodied and broadly described herein, the disclosure, in one aspect, relates to a method comprising: adding a slurry to a container, wherein the slurry comprises water and an ore sample; injecting CO₂ into the container until a target partial pressure of CO₂ is reached; and heating the mixture of the slurry and CO₂, thereby forming a treated slurry. The disclosure also relates to a method, comprising: adding a slurry to a sealable container, wherein the slurry comprises water and an ore sample; injecting CO₂ into the sealable container until a target partial pressure of CO₂ is reached; and grinding the slurry, thereby forming a ground slurry. The disclosure also relates to a method, comprising: performing an ex-situ treatment on a slurry, wherein the slurry comprises water and an ore sample, the ex-situ treatment comprising: adding the slurry to a first container; injecting CO₂ into the first container until a first target partial pressure of CO₂ is reached; and heating the mixture of the slurry and CO₂, thereby forming a treated slurry; and performing an in-situ treatment on the treated slurry, the in-situ treatment comprising: adding the treated slurry to a second container; injecting CO₂ into the second container until a second target partial pressure of CO₂ is reached; and grinding the treated slurry, thereby forming a ground slurry.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described aspects are usable in all aspects of the disclosure taught herein. Furthermore, the individual features of the dependent claims, as well as all optional and preferred features and modifications of the described aspects are combinable and interchangeable with one another.

### BRIEF DESCRIPTION OF THE FIGURES

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIGS. 1A-1B show a representative XRD of bastnaesite (FIG. 1A) and chalcopyrite (FIG. 1B).

FIG. 2 shows a representative experimental procedure for evaluating the effect of ex-situ CO₂ treatment on ore grindability.

FIGS. 3A-3B show +75 μm particles in bastnaesite (FIG. 3A) and chalcopyrite grinding products.

FIG. 4 shows a representative grinding curve of bastnaesite.

FIGS. 5A-5C show representative effects of ex-situ CO₂ treatment time on particle size distribution of bastnaesite (pressure=100 psi; concentration=50%; temperature=21° C.): Yield of +75 μm particles (FIG. 5A); Cumulative size distribution of −75 μm particles (FIG. 5B); and P₈₀ of −75 μm particles (FIG. 5C).

FIGS. 6A-6C show representative effects of ex-situ CO₂ treatment pulp concentration on particle size distribution of bastnaesite (pressure=100 psi; time=3 h; temperature=21° C.): Yield of +75 μm particles (FIG. 6A); Cumulative size distribution of −75 μm particles (FIG. 6B); and P₈₀ of −75 μm particles (FIG. 6C).

FIGS. 7A-7C show representative effects of ex-situ CO₂ treatment pressure on particle size distribution of bastnaesite (concentration=50%; time=3 h; temperature=21° C.): Yield of +75 μm particles (FIG. 7A); Cumulative size distribution of −75 μm particles (FIG. 7B); and P₈₀ of −75 μm particles (FIG. 7C).

FIGS. 8A-8C show representative effects of ex-situ CO₂ treatment temperature on particle size distribution of bastnaesite (concentration=50%; time=3 h; pressure=100 psi): Yield of +75 μm particles (FIG. 8A); Cumulative size distribution of −75 μm particles (FIG. 8B); and P₈₀ of −75 μm particles (FIG. 8C).

FIGS. 9A-9B show representative effects of ex-situ CO₂ treatment on full particle size distribution of bastnaesite (concentration=50%; time=3 h; pressure=100 psi, temperature =18° C.): Cumulative size distribution (FIG. 9A) and P₈₀ of full particle sizes (FIG. 9B).

FIG. 10 shows a representative grinding curve of chalcopyrite.

FIGS. 11A-11C show representative effects of ex-situ CO₂ treatment time on particle size distribution of chalcopyrite (pressure=100 psi; concentration=50%; temperature=21° C.): Yield of +75 μm particles (FIG. 11A); Cumulative size distribution of −75 μm particles (FIG. 11B); and P₈₀ of −75 μm particles (FIG. 11C).

FIGS. 12A-12C show representative effects of ex-situ CO₂ treatment pulp concentration on particle size distribution of chalcopyrite (pressure=100 psi; time=5 h; temperature=21° C.): Yield of +75 μm particles (FIG. 12A); Cumulative size distribution of −75 μm particles (FIG. 5B); and P₈₀ of −75 μm particles (FIG. 12C).

FIGS. 13A-7C show representative effects of ex-situ CO₂ treatment pressure on particle size distribution of chalcopyrite (concentration=50%; time=5 h; temperature=21° C.): Yield of +75 μm particles (FIG. 13A); Cumulative size distribution of −75 μm particles (FIG. 13B); and P₈₀ of −75 μm particles (FIG. 13C).

FIGS. 14A-8C show representative effects of ex-situ CO₂ treatment temperature on particle size distribution of chalcopyrite (concentration=50%; time=5 h; pressure=100 psi): Yield of +75 μm particles (FIG. 14A); Cumulative size distribution of −75 μm particles (FIG. 14B); and P₈₀ of −75 μm particles (FIG. 14C).

FIGS. 15A-15B show representative effects of ex-situ CO₂ treatment on full particle size distribution of chalcopyrite (concentration=50%; time=5 h; pressure=100 psi, temperature=18° C.): Cumulative size distribution (FIG. 15A) and P₈₀ of full particle sizes (FIG. 15B).

FIGS. 16A-16C show representative effectiveness of ex-situ supercritical CO₂ treatment on the grindability of bastnaesite under different pulp concentrations (Treatment time=1 h): Yield of +75 μm particles (FIG. 16A); Cumulative size distribution of −75 μm particles (FIG. 16B); and P₈₀ of −75 μm particles (FIG. 16C).

FIGS. 17A-17C show representative effectiveness of ex-situ supercritical CO₂ treatment on the grindability of bastnaesite under different times (pulp concentration=50%): Yield of +75 μm particles (FIG. 17A); Cumulative size distribution of −75 μm particles (FIG. 17B); and P₈₀ of −75 μm particles (FIG. 17C).

FIGS. 18A-18C show representative effectiveness of ex-situ supercritical CO₂ treatment on the grindability of chalcopyrite under different pulp concentrations (treatment time=1 h): Yield of +75 μm particles (FIG. 18A); Cumulative size distribution of −75 μm particles (FIG. 18B); and P₈₀ of −75 μm particles (FIG. 18C).

FIGS. 19A-19C show representative effectiveness of ex-situ supercritical CO₂ treatment on the grindability of chalcopyrite under different times (pulp concentration=50%): Yield of +75 μm particles (FIG. 19A); Cumulative size distribution of −75 μm particles (FIG. 19B); and P₈₀ of −75 μm particles (FIG. 19C).

FIG. 20 shows a representative experimental procedure for evaluating the effect of in-situ CO₂ treatment on ore grindability.

FIG. 21 shows a representative grinding curve of bastnaesite.

FIGS. 22A-22C show representative effects of in-situ CO₂ treatment pressure on particle size distribution of bastnaesite (concentration=67%; time=3.5 min; temperature=18° C.): Yield of +75 μm particles (FIG. 22A); Cumulative size distribution of −75 μm particles (FIG. 22B); and P₈₀ of −75 μm particles (FIG. 22C).

FIGS. 23A-23B show representative effects of in-situ CO₂ treatment pressure on full particle size distribution of bastnaesite (concentration=67%; time=3.5 min; temperature=18° C.): Cumulative size distribution (FIG. 23A) and P₈₀ of full particle size (FIG. 23B).

FIGS. 24A-24C show representative effectiveness of in-situ CO₂ treatment of bastnaesite under different grinding times (pressure=100 psi; concentration=67%): Yield of +75 μm particles (FIG. 24A); Cumulative size distribution of −75 μm particles (FIG. 24B); and P₈₀ of −75 μm particles (FIG. 24C).

FIGS. 25A-25B show representative effectiveness of in-situ CO₂ treatment of bastnaesite under different grinding times (pressure=100 psi; concentration=67%): Cumulative size distribution (FIG. 25A) and P₈₀ of full particle size (FIG. 25B).

FIGS. 26A-26C show representative effectiveness of in-situ CO₂ treatment of bastnaesite under different pulp concentrations (pressure=100 psi; grinding time=3.5 min): Yield of +75 μm particles (FIG. 26A); Cumulative size distribution of −75 μm particles (FIG. 26B); and P₈₀ of −75 μm particles (FIG. 26C).

FIGS. 27A-27B show representative effectiveness of in-situ CO₂ treatment of bastnaesite under different pulp concentrations (pressure=100 psi; grinding time=3.5 min): Cumulative size distribution (FIG. 27A) and P₈₀ of full particle size (FIG. 27B).

FIG. 28 shows a representative grinding curve of chalcopyrite.

FIGS. 29A-29C show representative effects of in-situ CO₂ treatment pressure on particle size distribution of chalcopyrite (concentration=67%; time=4.5 min; temperature=18° C.): Yield of +75 μm particles (FIG. 29A); Cumulative size distribution of −75 μm particles (FIG. 29B); and P₈₀ of −75 μm particles (FIG. 29C).

FIGS. 30A-30B show representative effects of in-situ CO₂ treatment pressure on full particle size distribution of chalcopyrite (concentration=67%; time=4.5 min; temperature=18° C.): Cumulative size distribution (FIG. 30A) and P₈₀ of full particle size (FIG. 30B).

FIGS. 31A-31C show representative effectiveness of in-situ CO₂ treatment of chalcopyrite under different grinding times (pressure=100 psi; concentration=67%): Yield of +75 μm particles (FIG. 31A); Cumulative size distribution of −75 μm particles (FIG. 31B); and P₈₀ of −75 μm particles (FIG. 31C).

FIGS. 32A-32B show representative effectiveness of in-situ CO₂ treatment of chalcopyrite under different grinding times (pressure=100 psi; concentration=67%): Cumulative size distribution (FIG. 32A) and P₈₀ of full particle size (FIG. 32B).

FIGS. 33A-33C show representative effectiveness of in-situ CO₂ treatment of chalcopyrite under different pulp concentrations (pressure=100 psi; grinding time=4.5 min): Yield of +75 μm particles (FIG. 33A); Cumulative size distribution of −75 μm particles (FIG. 33B); and P₈₀ of −75 μm particles (FIG. 33C).

FIGS. 34A-34B show representative effectiveness of in-situ CO₂ treatment of chalcopyrite under different pulp concentrations (pressure=100 psi; grinding time=4.5 min): Cumulative size distribution (FIG. 34A) and P₈₀ of full particle size (FIG. 34B).

FIGS. 35A-35B show representative effects of ex-situ CO₂+in-situ CO₂ treatment on the grindability of bastnaesite: Cumulative particle size distribution (FIG. 35A) and P₈₀ of full particle size (FIG. 35B).

FIGS. 36A-36B show representative effects of ex-situ CO₂+in-situ CO₂ treatment on the grindability of chalcopyrite: Cumulative particle size distribution (FIG. 36A) and P₈₀ of full particle size (FIG. 36B).

FIG. 37 shows a representative process of ex-situ and in-situ CO₂ treatment of ore.

FIGS. 38A-38D show various representative pretreatment conditions for bastnaesite ore without any treatment (FIG. 38A); ex-situ+in-situ CO₂ treatment (FIG. 38B); three-step CO₂ treatment and grinding: 1.5 min+1 min+1 min (FIG. 38C); and six-step CO₂ treatment and grinding: 35 s+35 s+35 s+35 s+35 s+35 s (FIG. 38D).

FIGS. 39A-39B show representative full particle size distribution of bastnaesite under different treatment conditions: Cumulative size distribution (FIG. 39A) and P₈₀ of full particle size (FIG. 39B).

FIGS. 40A-40D show representative distribution of each particle size of bastnaesite without any treatment (FIG. 40A); ex-situ+in-situ CO₂ treatment (FIG. 40B); three-step CO₂ treatment and grinding: 1.5 min+1 min+1 min (FIG. 40C); and six-step CO₂ treatment and grinding: 35 s+35 s+35 s+35 s+35 s+35 s (FIG. 40D).

FIGS. 41A-41D show various representative pretreatment conditions for chalcopyrite ore without any treatment (FIG. 41A); ex-situ+in-situ CO₂ treatment (FIG. 41B); three-step CO₂ treatment and grinding: 2.5 min+1 min+1 min (FIG. 41C); and six-step CO₂ treatment and grinding: 45 s+45 s+45 s+45 s+45 s+45 s (FIG. 41D).

FIGS. 42A-42B show representative full particle size distribution of chalcopyrite under different treatment conditions: Cumulative size distribution (FIG. 42A) and P₈₀ of full particle size (FIG. 42B).

FIGS. 43A-43D show representative distribution of each particle size of chalcopyrite without any treatment (FIG. 43A); ex-situ+in-situ CO₂ treatment (FIG. 43B); three-step CO₂ treatment and grinding: 2.5 min+1 min+1 min (FIG. 43C); and six-step CO₂ treatment and grinding: 45 s+45 s+45 s+45 s+45 s+45 s (FIG. 43D).

Additional advantages of the disclosure will be set forth in part in the description which follows, and in part will be obvious from the description, or can be learned by practice of the disclosure. The advantages of the disclosure will be realized and attained by means of the elements and combinations particularly pointed out in the appended claims. It is to be understood that both the foregoing general description and the following detailed description are exemplary and explanatory only and are not restrictive of the disclosure, as claimed.

### DETAILED DESCRIPTION

This disclosure is not limited to particular embodiments described, and as such may, of course, vary. The terminology used herein serves the purpose of describing particular embodiments only, and is not intended to be limiting, since the scope of the present disclosure will be limited only by the appended claims.

Where a range of values is provided, each intervening value, to the tenth of the unit of the lower limit unless the context clearly dictates otherwise, between the upper and lower limit of that range and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Embodiments of the present disclosure will employ, unless otherwise indicated, techniques of medicine, organic chemistry, biochemistry, molecular biology, pharmacology, and the like, which are within the skill of the art. Such techniques are explained fully in the literature.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1 percent to about 5 percent” should be interpreted to include not only the explicitly recited concentration of about 0.1 weight percent to about 5 weight percent but also include individual concentrations (e.g., 1 percent, 2 percent, 3 percent, and 4 percent) and the sub-ranges (e.g., 0.5 percent, 1.1 percent, 2.2 percent, 3.3 percent, and 4.4 percent) within the indicated range. The term “about” can include traditional rounding according to significant figures of the numerical value. In addition, the phrase “about ‘x’ to ‘y’” includes “about ‘x’ to about ‘y’”.

Furthermore, the terms “about”, “approximate”, “at or about”, and “substantially” as used herein mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Before the embodiments of the present disclosure are described in detail, it is to be understood that, unless otherwise indicated, the present disclosure is not limited to particular materials, reagents, reaction materials, manufacturing processes, dimensions, frequency ranges, applications, or the like, as such can vary. It is also to be understood that the terminology used herein is for purposes of describing particular embodiments only, and is not intended to be limiting. It is also possible in the present disclosure that steps can be executed in different sequence, where this is logically possible. It is also possible that the embodiments of the present disclosure can be applied to additional embodiments involving measurements beyond the examples described herein, which are not intended to be limiting. It is furthermore possible that the embodiments of the present disclosure can be combined or integrated with other measurement techniques beyond the examples described herein, which are not intended to be limiting.

It should be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

Each of the applications and patents cited in this text, as well as each document or reference cited in each of the applications and patents (including during the prosecution of each issued patent; “application cited documents”), and each of the PCT and foreign applications or patents corresponding to and/or claiming priority from any of these applications and patents, and each of the documents cited or referenced in each of the application cited documents, are hereby expressly incorporated herein by reference. Further, documents or references cited in this text, in a Reference List before the claims, or in the text itself; and each of these documents or references (“herein cited references”), as well as each document or reference cited in each of the herein-cited references (including any manufacturer's specifications, instructions, etc.) are hereby expressly incorporated herein by reference.

Prior to describing the various embodiments, the following definitions are provided and should be used unless otherwise indicated.

### A. Definitions

As used herein, “gangue” or “gangue minerals” refers to undesired material or minerals that surround or are co-located with target minerals. Gangue minerals can include, but are not limited to, calcite, quartz, and barite. In some aspects, gangue minerals and/or materials may have little or no economic value.

As used herein, “target minerals” refer to valuable metallic and/or non-metallic elements that can be extracted from ores. Target minerals can include critical minerals, such as aluminum, antimony, arsenic, barite, beryllium, bismuth, cerium, cesium, chromium, cobalt, dysprosium, erbium, europium, fluorspar, gadolinium, gallium, germanium, graphite, hafnium, holmium, indium, iridium, lanthanum, lithium, lutetium, magnesium, manganese, neodymium, nickel, niobium, palladium, platinum, praseodymium, rhodium, rubidium, ruthenium, samarium, scandium, tantalum, tellurium, terbium, thulium, tin, titanium, tungsten, vanadium, ytterbium, yttrium, zinc, and zirconium.

As used herein, the term “silicate mineral” or “silicate ore” refers to a mineral or ore that is comprised of or contains silicon-oxygen compounds (e.g., (SiO₄)⁴⁻, (SiO₃)²⁻, (Si₂O₅)²⁻. Examples of silicate minerals include, but are not limited to, olivine, serpentine, wollastonite, quartz, feldspar, mica, amphibole, and pyroxene.

As used herein, a “feedstock” refers to a raw material processed to recover target minerals and other valuable components.

### B. Abbreviations

### XRD X-Ray diffraction

### C. Discussion

The present disclosure provides for methods for treatment of an ore, such as a silicate ore, with CO₂ prior to and/or during grinding. The methods disclosed can be used on their own or in combination with one another to treat the ore. In one aspect, the methods disclosed herein can be used to reduce the mechanical strength of an ore. By reducing an ore's mechanical strength, grinding the ore can be made more efficient (e.g., less costly and faster to complete). Additionally, the methods disclosed herein result in CO₂ fixation and can aid in reducing carbon emissions. In one aspect, the method can include one or muti-steps of CO₂ application—including ex-situ treatment, in-situ treatment, and multi-step processing—to modify the hardness of the ore. For example, an ex-situ treatment may be applied as a pre-conditioning step where CO₂ is introduced to alter the ore's structural properties before the grinding process. Subsequently, an in-situ treatment may be performed during the grinding operation to further influence the mechanical characteristics of the ore. In one aspect, these treatments are executed in multiple sequential steps to achieve optimal modification of the ore's hardness, thereby improving its grindability and reducing the overall energy consumption in subsequent comminution processes.

Carbon mineralization is an effective carbon capture and storage technology that converts CO₂ produced in the atmosphere or industrial processes into solid minerals, thereby reducing greenhouse gas emissions. This process usually involves CO₂ reacting with minerals containing metal ions (such as magnesium and calcium) to form stable carbonate minerals such as calcite (CaCO₃) or dolomite (CaMg(CO₃)₂). As one example, common silicate gangue minerals containing calcium and magnesium, such as olivine and serpentine, can be used for carbon mineralization. The main reactions involved are:
Olivine: Mg₂SiO₄+2CO₂→2MgCO₃+SiO₂
Serpentine: Mg₃Si₂O₅(OH)₄+3CO₂→3MgCO₃+2SiO₂+2H₂O
Wollastonite: CaSiO₃+CO₂→CaCO₃+SiO₂

As can be seen from the above carbon mineralization reaction process, a loose carbonate layer will be formed on the mineral surface, which will reduce the hardness of the mineral surface layer. At the same time, the reaction will cause new cracks in the ore, further reducing the mechanical strength of the ore, which means that the ore's grindability will be improved.

In one aspect, the method disclosed herein comprises adding a slurry to a container (e.g., a sealable container that can be pressurized above 1 ATM and/or include a CO₂ concentration above that normally found in the atmosphere), where the slurry includes an aqueous fluid (e.g., water) and an ore sample. The method can further comprise injecting CO₂ into the container until a target partial pressure of CO₂ is reached; and heating the mixture of the slurry and CO₂, thereby forming a treated slurry. The container can be a sealed and/or high-pressure reactor (e.g., autoclave). The CO₂ injection can be accomplished using a CO₂ gas delivery system that is in gaseous communication (e.g., via tubing, valves, pressure regulators, etc.) with the container. The CO₂ gas delivery system can include a source of CO₂, such as a pressurized CO₂ cylinder, air, and a gaseous mixture containing CO₂. The mixture of the slurry and CO₂ can be heated using a furnace, hot air, or the like. In one aspect, the slurry may further include additional additives, such as sodium salts (e.g., sodium bicarbonate), ammonium salts, chloride salts, and any combination thereof. Examples of ammonium salts include ammonium carbonate, ammonium bicarbonate, ammonium sulfate, and ammonium bisulfate. Additional additives can include compounds that can contribute to further reducing the mechanical strength of the ore sample. The ore sample in the slurry can react with the CO₂ to form a treated ore sample.

In one aspect, the concentration of ore in the slurry can range from about 20% to about 99%, about 20% to about 90%, about 30% to about 90%, about 30% to about 80%, about 40% to about 80%, about 50% to about 80%, or about 40% to about 60%. In one aspect, the CO₂ and slurry mixture can be heated to a temperature of about 10° C. to about 200° C. for about 0.25 hours to about 10 hours. In a further aspect, the mixture can be heated to a temperature of about 18° C. to about 185° C., about 18° C. to about 150° C., about 18° C. to about 125° C., about 18° C. to about 100° C., about 20° C. to about 100° C., or about 20° C. to about 75° C. In one aspect, the mixture can be heated to a temperature of about 18° C. to about 22° C. or about standard temperature of 20° C. In another aspect, the mixture can be treated for about 0.5 hours to about 8 hours, about 1 hour to about 7 hours, about 2 hours to about 8 hours, about 2 hours to about 6 hours, about 3 hours to about 6 hours, about 4 hours to about 6 hours, or about 5 hours. In one aspect, the target partial pressure of CO₂ can be greater than 0 psi. In a further aspect, the target partial pressure of CO₂ can range from about 50 psi to about 1300 psi, about 100 psi to about 1200 psi, about 10 psi to about 200 psi, about 50 psi to about 125 psi, about 900 psi to about 1200 psi, or about 1000 psi to about 1100 psi.

In one aspect, the method can further include drying the treated slurry, thereby forming a concentrated slurry and grinding the concentrated slurry. The concentrated slurry can be ground using known milling technologies (e.g., wet grinding, dry grinding, ball milling, and the like). The treated slurry can optionally be filtered prior to, after, or during drying. In a further aspect, the treated slurry has been removed from the container with pressurized CO₂ prior to drying, prior to grinding, or prior to performing both. The concentrated slurry can comprise a higher concentration of ore compared to the treated slurry. In one aspect, the concentration of ore in the concentrated slurry can range from about 30% to about 99%, about 30% to about 90%, about 30% to about 80%, about 40% to about 99%, about 40% to about 90%, about 50% to about 90%, about 50% to about 80%, or about 60% to about 90%.

The CO₂ in the mixture can be in a supercritical state. In one aspect, the temperature of the mixture is at least 31° C. and the partial pressure of CO₂ is at least 1072 psi, so that the CO₂ is in a supercritical state. In another aspect, the mixture is heated to a temperature of from about 31° C. to about 45° C. with a CO₂ partial pressure of about 1072 psi to about 1300 psi.

In another aspect, the method disclosed herein comprises adding a slurry to a container (e.g., a sealable container that can be pressurized above 1 ATM and/or include a CO₂ concentration above that normally found in the atmosphere), where the slurry includes an aqueous fluid (e.g., water) and an ore sample. The method can further comprise injecting CO₂ into the sealable container until a target partial pressure of CO₂ is reached; and grinding the slurry, thereby forming a ground slurry. In a further aspect, the slurry is ground while it is kept at the target partial pressure of CO₂. In one aspect, the slurry can include an ore sample pre-treated with CO₂ using any of the methods disclosed herein. The container can be or be a component of a ball mill, rod mill, pebble mill, or any mill used for wet grinding, dry grinding, mixing, and/or blending of materials like ores. The CO₂ can be injected into the container until a target partial pressure of CO₂ is reached. The CO₂ injection can be accomplished using a CO₂ gas delivery system that is in gaseous communication (e.g., via tubing, valves, pressure regulators, etc.) with the container. The CO₂ gas delivery system can include a source of CO₂, such as a pressurized CO₂ cylinder, air, and a gaseous mixture containing CO₂. In one aspect, the slurry may further include additional additives, such as sodium salts (e.g., sodium bicarbonate), ammonium salts, chloride salts, and any combination thereof. Examples of ammonium salts include ammonium carbonate, ammonium bicarbonate, ammonium sulfate, and ammonium bisulfate. Additional additives can include compounds that can contribute to further reducing the mechanical strength of the ore sample. The slurry can be ground using known milling technologies (e.g., wet grinding, dry grinding, ball milling, and the like).

In one aspect, target partial pressure of CO₂ can be greater than 0 psi or greater than 100 psi. In a further aspect, the target partial pressure of CO₂ can range from about 50 psi to about 1300 psi, about 100 psi to about 1200 psi, about 10 psi to about 200 psi, about 50 psi to about 125 psi, about 900 psi to about 1200 psi, about 1000 psi to about 1100 psi, or about 1 psi to about 100 psi. In one aspect, the concentration of ore in the slurry can range from about 30% to about 99%, about 30% to about 90%, about 30% to about 80%, about 40% to about 99%, about 40% to about 90%, about 50% to about 99%, about 50% to about 90%, about 50% to about 80%, or about 60% to about 90%.

In another aspect, the method disclosed herein comprises performing an ex-situ treatment on a slurry, wherein the slurry comprises an aqueous fluid (e.g., water) and an ore sample, thereby forming a treated slurry, and performing an in-situ treatment on the treated slurry. The ex-situ treatment can comprise adding the slurry to a first container, wherein the slurry comprises water and an ore sample; injecting CO₂ into the first container until a first target partial pressure of CO₂ is reached; and heating the mixture of the slurry and CO₂, thereby forming a treated slurry. The in-situ treatment can comprise adding the treated slurry to a second container; injecting CO₂ into the second container until a second target partial pressure of CO₂ is reached; and grinding the treated slurry, thereby forming a ground slurry. In a further aspect, the treated slurry is ground while it is kept at the second target partial pressure of CO₂.

Either one of the first container or the second container can be a sealable container that can be pressurized above 1 ATM and/or include a CO₂ concentration above that normally found in the atmosphere). In one aspect, the first container can be a high-pressure reactor (e.g., autoclave). In another aspect, the second container can be or be a component of a ball mill, rod mill, pebble mill, or any mill used for wet grinding, dry grinding, mixing, and/or blending of materials like ores. The CO₂ injection can be accomplished using a CO₂ gas delivery system that is in gaseous communication (e.g., via tubing, valves, pressure regulators, etc.) with the container. The CO₂ gas delivery system can include a source of CO₂, such as a pressurized CO₂ cylinder, air, and a gaseous mixture containing CO₂. In one aspect, the slurry may further include additional additives, such as sodium salts (e.g., sodium bicarbonate), ammonium salts, chloride salts, and any combination thereof. Examples of ammonium salts include ammonium carbonate, ammonium bicarbonate, ammonium sulfate, and ammonium bisulfate. Additional additives can include compounds that can contribute to further reducing the mechanical strength of the ore sample. The treated slurry can be ground using known milling technologies (e.g., wet grinding, dry grinding, ball milling, and the like).

In one aspect, the concentration of ore in the slurry can range from about 20% to about 99%, about 20% to about 90%, about 30% to about 90%, about 30% to about 80%, about 40% to about 80%, about 50% to about 80%, or about 40% to about 60%. In one aspect, the CO₂ and slurry mixture can be heated to a temperature of about 10° C. to about 200° C. for about 0.25 hours to about 10 hours. In a further aspect, the mixture can be heated to a temperature of about 18° C. to about 185° C., about 18° C. to about 150° C., about 18° C. to about 125° C., about 18° C. to about 100° C., about 20° C. to about 100° C., or about 20° C. to about 75° C. In one aspect, the mixture can be heated to a temperature of about 18° C. to about 22° C. or about standard temperature of 20° C. In another aspect, the mixture can be treated for about 0.5 hours to about 8 hours, about 1 hour to about 7 hours, about 2 hours to about 8 hours, about 2 hours to about 6 hours, about 3 hours to about 6 hours, about 4 hours to about 6 hours, or about 5 hours. In one aspect, the first and second target partial pressures of CO₂ can be greater than 0 psi or greater than 100 psi. In a further aspect, the first target partial pressure of CO₂ can range from about 50 psi to about 1300 psi, about 100 psi to about 1200 psi, about 10 psi to about 200 psi, about 50 psi to about 125 psi, about 900 psi to about 1200 psi, or about 1000 psi to about 1100 psi. In another further aspect, the second target partial pressure of CO₂ can range from about 50 psi to about 1300 psi, about 100 psi to about 1200 psi, about 10 psi to about 200 psi, about 50 psi to about 125 psi, about 900 psi to about 1200 psi, about 1000 psi to about 1100 psi, or about 1 psi to about 100 psi.

In one aspect, the method can further include drying the treated slurry prior to adding it to the second container. The treated slurry can optionally be filtered prior to, after, or during drying. In a further aspect, the treated slurry has been removed from the first container prior to drying. The treated slurry can comprise a higher concentration of ore after drying. In one aspect, the concentration of ore in the treated slurry after drying can range from about 30% to about 99%, about 30% to about 90%, about 30% to about 80%, about 40% to about 99%, about 40% to about 90%, about 50% to about 99%, about 50% to about 90%, about 50% to about 80%, or about 60% to about 90%.

In another aspect, the method can further comprise repeating the ex-situ treatment and the in-situ treatment. The treatments can be repeated from 2 to 10 times, from 2 to 8 times, from 2 to 6 times, or from 3 to 6 times, where a single repetition includes both the ex-situ and the in-situ treatment. In another aspect, the treatments can be repeated until a target particle size of the slurry or treated slurry is achieved.

For any of the grinding steps in the methods disclosed herein, the slurries can be ground for a specific range of time or to achieve a specific particle size. In one aspect, the treated slurry can be ground for about 15 seconds to about 60 minutes, about 30 seconds to about 50 minutes, about 30 seconds to about 30 minutes, about 30 seconds to about 15 minutes, or about 30 seconds to about 5 minutes. In another aspect, the slurry is ground until the ore sample in the ground slurry achieves a particle size of about 0.01 mm to about 0.2 mm, or about 0.01 mm to about 0.15 mm, about 0.05 mm to about 0.15 mm, about 0.05 mm to about 0.10 mm, or about 0.01 mm to 0.10 mm. The particle size can be evaluated as the 80% cumulative passing size or P₈₀.

The CO₂ used in the methods disclosed herein can be obtained from a variety of sources. In one aspect, the CO₂ can be captured from power plant emissions and/or other industrial source emissions. CO₂ can also be captured from activities related to mining, such as from vehicles used to haul recovered material, such as ores, and bulldozers. Additional examples of CO₂ sources for capture include vehicle exhaust, geological movement, and degradation of organic matter. In another aspect, the CO₂ can be obtained more directly from the atmosphere.

Ores of the present disclosure can include any ore that contains target minerals or minerals of value for recovery. In one aspect, the ores of the present disclosure can undergo reactions in the presence of CO₂, such as undergoing carbon mineralization. Examples of ores include chalcopyrite and bastnaesite.

The methods of the present disclosure can aid in reducing the mechanical strength of an ore prior to or during grinding. After CO₂ treatment, the ore may be ground easier compared to a similar ore that has not undergone CO₂ treatment. For example, an ore treated via any method of the present disclosure (including grinding) can have a smaller average particle size compared to an equivalent ore that has been ground but not treated with CO₂.

While embodiments of the present disclosure are described in connection with the Examples and the corresponding text and figures, there is no intent to limit the disclosure to the embodiments in these descriptions. On the contrary, the intent is to cover all alternatives, modifications, and equivalents included within the spirit and scope of embodiments of the present disclosure.

### D. Aspects

The following listing of exemplary aspects supports and is supported by the disclosure provided herein.

Aspect 1. A method, comprising: adding a slurry to a container, wherein the slurry comprises water and an ore sample; injecting CO₂ into the container until a target partial pressure of CO₂ is reached; and heating the mixture of the slurry and CO₂, thereby forming a treated slurry.

Aspect 2. The method of aspect 1, wherein the concentration of the ore sample in the slurry is about 20% to about 99%.

Aspect 3. The method of aspect 1, wherein the concentration of the ore sample in the slurry is about 30% to about 80%.

Aspect 4. The method of any one of aspects 1-3, wherein the slurry further comprises sodium bicarbonate.

Aspect 5. The method of any one of aspects 1-4, wherein the target partial pressure of CO₂ is about 100 psi to about 1200 psi.

Aspect 6. The method of any one of aspects 1-5, wherein the mixture is heated to a temperature of about 18° C. to about 185° C. for about 0.5 hours to about 8 hours.

Aspect 7. The method of aspect 6, wherein the mixture is heated for about 3 hours to about 5 hours.

Aspect 8. The method of any one of aspect 1-7, further comprising: drying the treated slurry, thereby forming a concentrated slurry; and grinding the concentrated slurry.

Aspect 9. The method of aspect 8, wherein the concentrated slurry is ground for about 1 minute to about 60 minutes.

Aspect 10. The method of aspect 8, wherein the concentrated slurry comprises ore particles, and further comprising grinding the concentrated slurry until the ore particles have a particle size of about 0.01 mm to about 0.15 mm.

Aspect 11. A method, comprising: adding a slurry to a sealable container, wherein the slurry comprises water and an ore sample; injecting CO₂ into the sealable container until a target partial pressure of CO₂ is reached; and grinding the slurry, thereby forming a ground slurry.

Aspect 12. The method of aspect 11, wherein the concentration of the ore sample in the slurry is about 30% to about 99%.

Aspect 13. The method of aspect 11, wherein the concentration of the ore sample in the slurry is about 50% to about 80%.

Aspect 14. The method of any one of aspects 11-13, wherein the slurry further comprises sodium bicarbonate.

Aspect 15. The method of any one of aspects 11-14, wherein the partial pressure of CO₂ is about 1 psi to about 100 psi.

Aspect 16. The method of any one of aspects 11-15, wherein the slurry is ground for about 1 minute to about 60 minutes.

Aspect 17. The method of any one of aspects 11-15, wherein the slurry comprises ore particles and wherein the slurry is ground until the ore particles have a particle size of about 0.01 mm to about 0.15 mm.

Aspect 18. The method of any one of aspects 11-17, wherein the slurry comprises an ore sample that is pre-treated via the method of aspect 1.

Aspect 19. The method of any one of aspects 11-18 wherein the ground slurry comprises ground ore particles and wherein the ground ore particles have a smaller particle size compared to an equivalent ground slurry that has not been mixed with CO₂.

Aspect 20. A method, comprising: performing an ex-situ treatment on a slurry, wherein the slurry comprises water and an ore sample, the ex-situ treatment comprising: adding the slurry to a first container; injecting CO₂ into the first container until a first target partial pressure of CO₂ is reached; and heating the mixture of the slurry and CO₂, thereby forming a treated slurry; and performing an in-situ treatment on the treated slurry, the in-situ treatment comprising: adding the treated slurry to a second container; injecting CO₂ into the second container until a second target partial pressure of CO₂ is reached; and grinding the treated slurry, thereby forming a ground slurry.

Aspect 21. The method of aspect 20, wherein the concentration of the ore sample in the treated slurry is about 50% to about 99%.

Aspect 22. The method of aspect 20 or aspect 21, further comprising repeating the ex-situ treatment and the in-situ treatment, wherein the ground slurry from the previous in-situ treatment is used as the slurry for the ex-situ treatment.

Aspect 23. The method of any one of aspects 20-22, further comprising repeating the ex-situ treatment and the in-situ treatment from 2 to 10 times, wherein the ground slurry from a previous in-situ treatment is used as the slurry for a next ex-situ treatment.

Aspect 24. The method of any one of aspects 20-23, wherein the concentration of the ore sample in the slurry is about 20% to about 99%.

Aspect 25. The method of any one of aspects 20-24, wherein the slurry further comprises sodium bicarbonate.

Aspect 26. The method of any one of aspects 20-25, wherein the first target partial pressure of CO₂ is about 100 psi to about 1200 psi.

Aspect 27. The method of any one of aspects 20-26, wherein the second target partial pressure of CO₂ is about 1 psi to about 100 psi.

Aspect 28. The method of any one of aspects 20-27, wherein the mixture is heated to a temperature of about 18° C. to about 185° C. for about 0.5 hours to about 8 hours.

Aspect 29. The method of any one of aspects 20-28, wherein the treated slurry is ground for about 1 minute to about 60 minutes.

Aspect 30. The method of any one of aspects 20-29, wherein the treated slurry comprises ore particles, and wherein the treated slurry is ground until the ore particles have a particle size of about 0.01 mm to about 0.15 mm.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### E. EXAMPLE 1

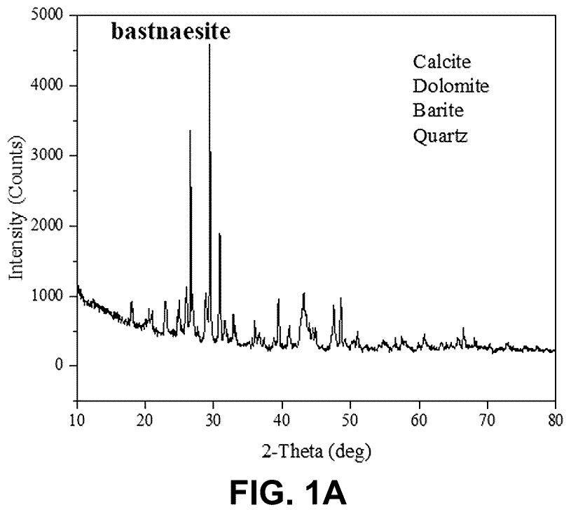

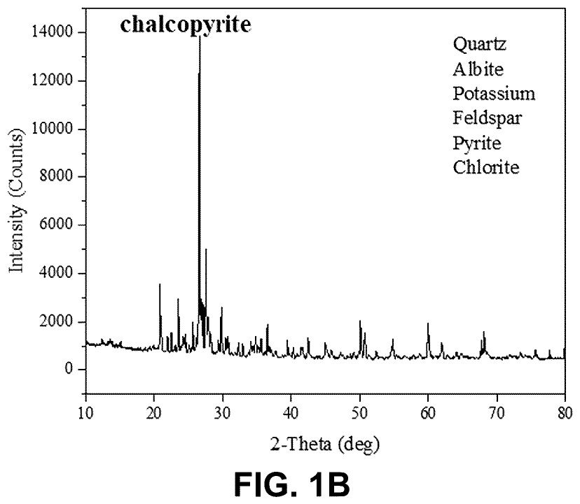

Mineral Sample. Discussed herein is a method used to treat certain silicate minerals that contain bastnaesite, such as quartz, and that contain chalcopyrite, such as quartz, albite, potassium feldspar, chlorite and so on (FIGS. 1A-1B). The silicate minerals in the ore create conditions for carbon mineralization.

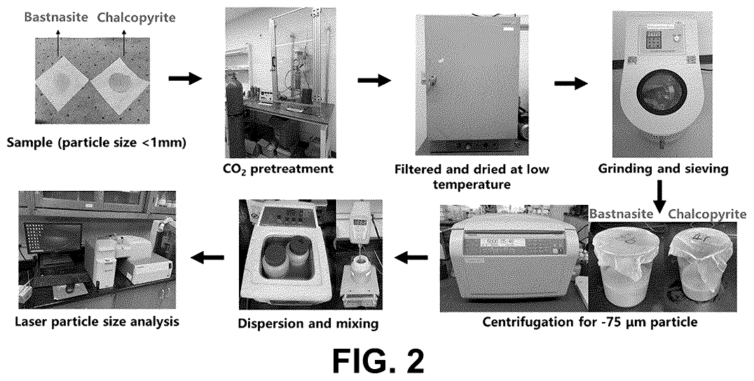

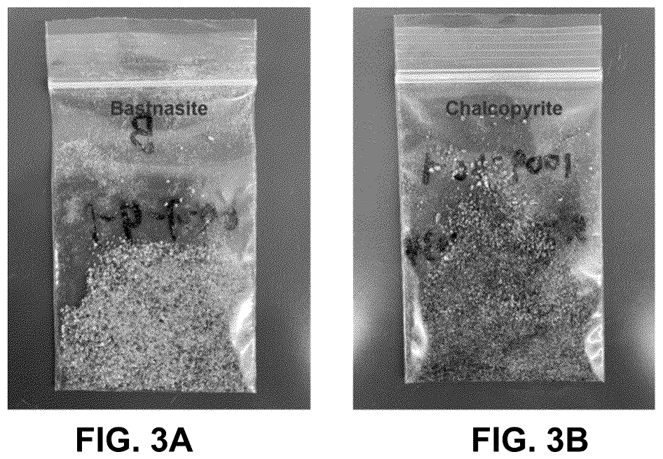

Ex-situ CO₂ treatment—Experimental method of ex-situ CO₂ treatment. The experimental procedure for evaluating the effect of ex-situ CO₂ treatment on ore grindability is shown in FIG. 2. The bastnaesite and chalcopyrite samples are crushed to the particle size of −1 mm and homogenized for subsequent testing and analysis. Each time, 20.0 g of sample and a certain amount of deionized (DI) water are taken and placed in the high-pressure reactor (Parr Instrument Company, P ST FS) for ex-situ CO₂ pretreatment. The pretreated samples are filtered and dried at low temperature before grinding and sieving. Grinding is done using a planetary ball mill (PQ-N04) with a rotational speed of 400 rpm and a pulp concentration of 67%. As shown in FIGS. 3A-3B, the coarse-grained refractory particles such as quartz in grinding products can cause the accuracy of laser particle size analysis to be reduced. To ensure the accuracy of particle size analysis, the grinding products are wet-sieved using a 200-mesh (75 μm) sieve. The products above the sieve are filtered and dried to calculate the yield, while the products below the sieve are fully dispersed after adding 10 mL of saturated sodium hexametaphosphate solution and then subjected to particle size distribution testing using a laser particle size analyzer (Microtrac S3500).

Ex-situ CO₂ treatment—Effect of ex-situ CO₂ treatment on the grindability of bastnaesite.

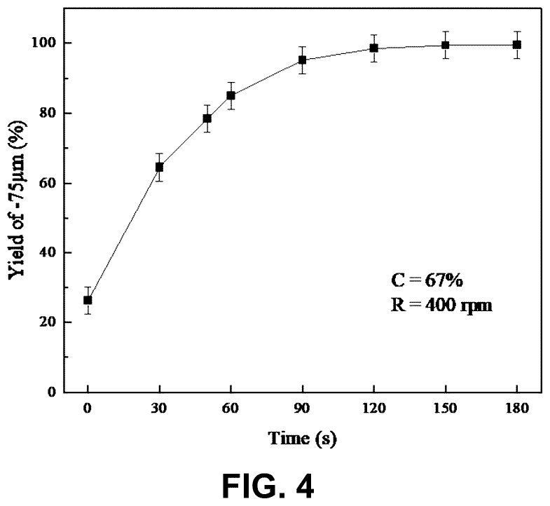

Grinding curve of bastnaesite: The reasonable grinding time is determined to better evaluate the grindability of bastnaesite. As presented in FIG. 4, the planetary mill rotational speed and pulp concentration are fixed at 400 rpm and 67%, respectively. As the grinding time increases, the yield of −75 μm particles gradually increases. After the grinding time exceeds 90 s, the yield of −75 μm particles reaches more than 95% and the increase trend slows down. When the grinding time is 50 s, the yield of −75 μm particles is 78.35%, which meets the requirements of the beneficiation process in industrial production. Therefore, the subsequent grinding time was fixed at 50 s to investigate the effect of ex-situ CO₂ treatment on the grindability of bastnaesite.

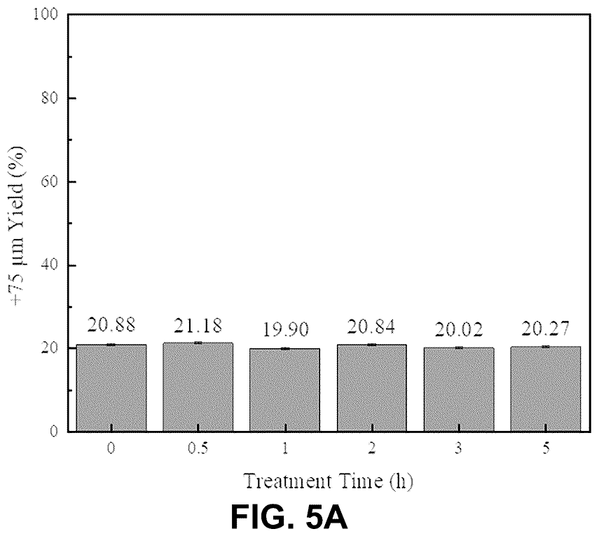

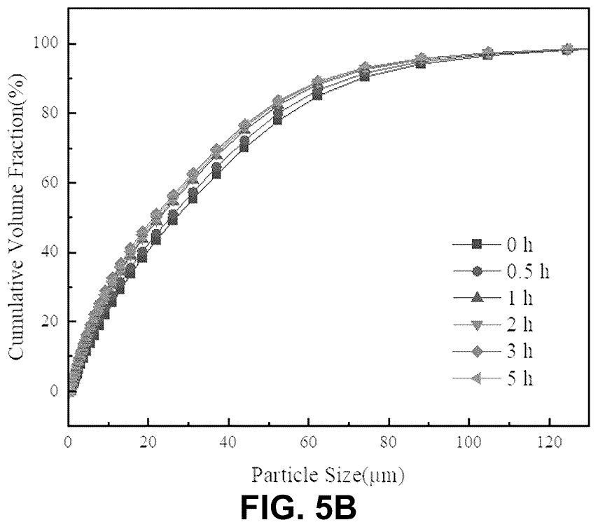

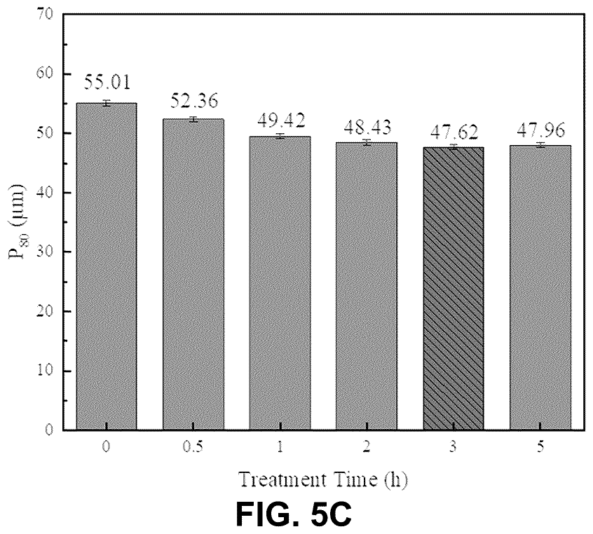

Effect of ex-situ CO₂ treatment time on the grindability of bastnaesite: The effect of ex-situ CO₂ treatment time on the cumulative distribution of each particle size of bastnaesite was first studied. As shown in FIGS. 5A-5C, the pressure of CO₂ introduced into the high-pressure reactor is fixed at 100 psi, the slurry concentration is fixed at 50%, and the treatment temperature is fixed at 21° C. The results of laser particle size analysis present that the size distribution of −75 μm particles shows an overall decreasing trend with the increase of ex-situ CO₂ treatment time. When the ex-situ CO₂ treatment time is 3 h, the P₈₀ of −75 μm particles drops from 55.01 μm to a smaller value of 47.62 μm, with a decrease of 13.43%. Therefore, the ex-situ CO₂ treatment plays a catalytic role in the grindability of bastnaesite. 3 h was selected as the fixed treatment time for subsequent experimental studies of other factors.

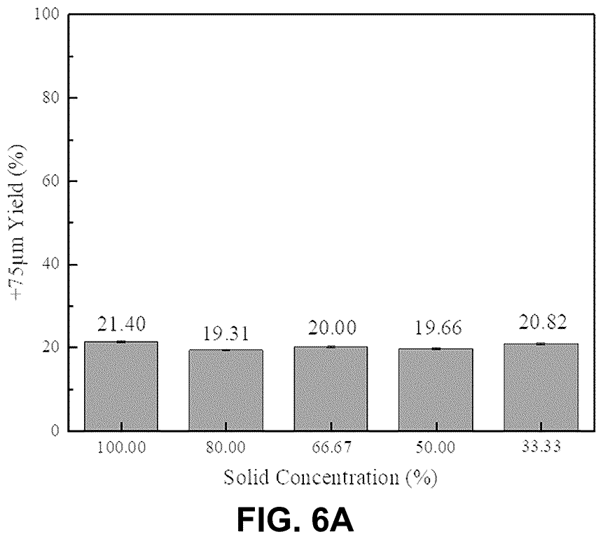

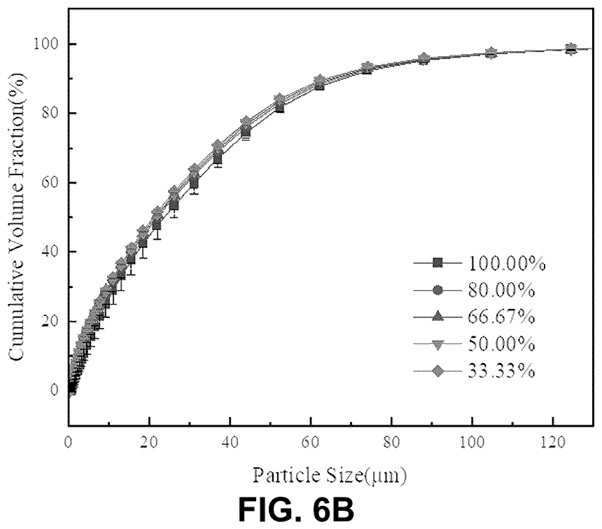

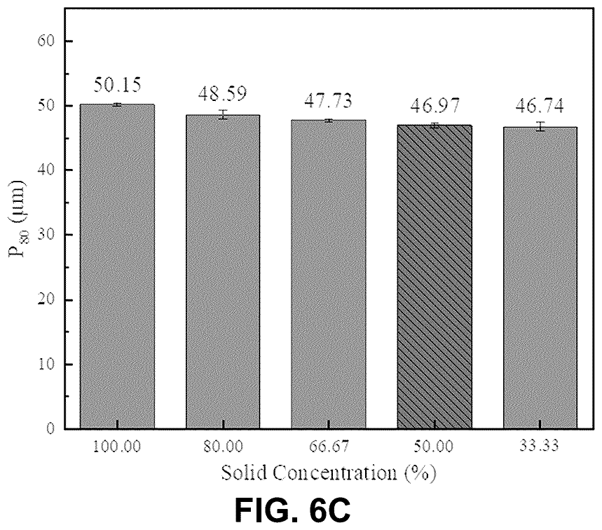

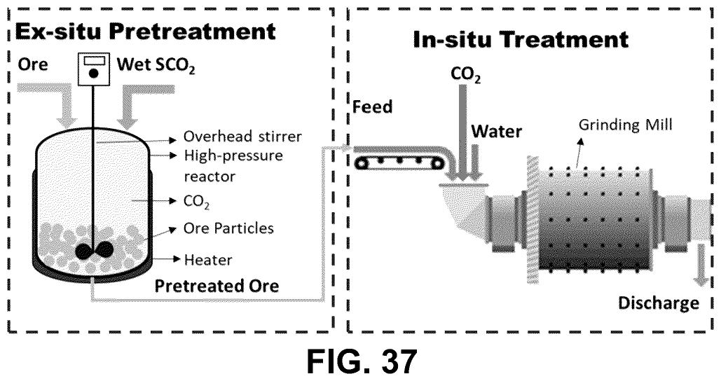

Effect of ex-situ CO₂ treatment concentration on the grindability of bastnaesite: Under the conditions of a fixed treatment time of 3 h and a constant CO₂ injection pressure of 100 psi, the effect of ex-situ CO₂ treatment pulp concentration on the grindability of bastnaesite was investigated. FIGS. 6A-6C illustrate that the size distribution of −75 μm particles becomes finer as the pulp concentration decreases. In the absence of water, the P₈₀ of −75 μm particles drops from 55.01 μm (FIG. 5C) to 50.15 μm compared to that without CO₂ treatment. When the pulp concentration is 33.33%, the P₈₀ of −75 μm particles continues to decrease to 46.74 μm. The presence of water promotes the reaction between CO₂ and minerals, further improving the grindability of bastnaesite. Taking into account the reasonable water consumption and the feasibility of the process flow, 50% of pulp concentration was selected for ex-situ CO₂ treatment. At this time, the P₈₀ of −75 μm particles is 46.97 μm, which is close to the P₈₀ when the slurry concentration is 33.33%.

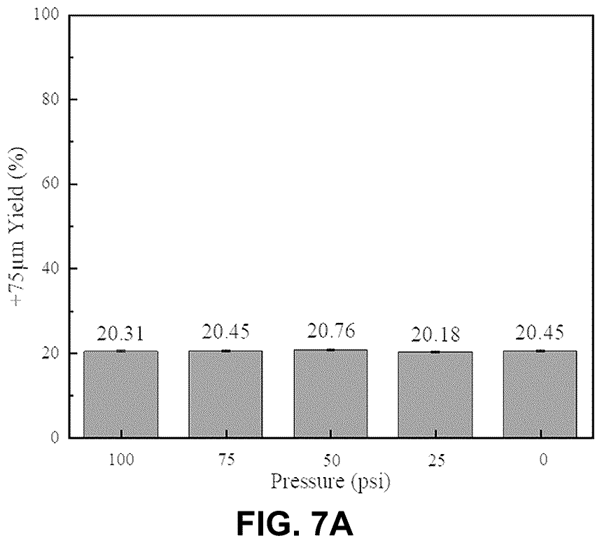

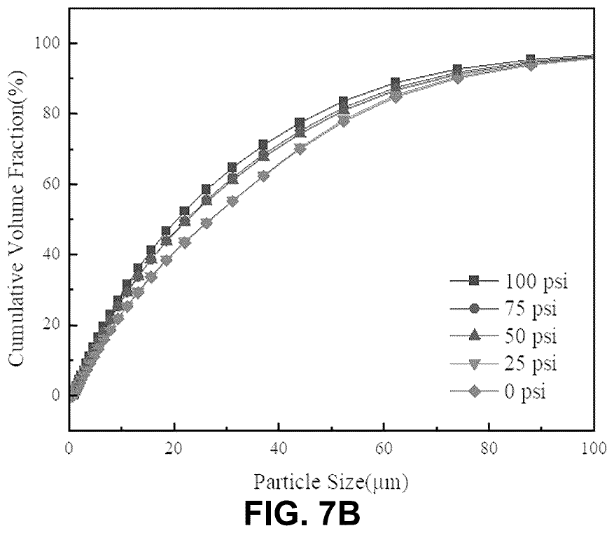

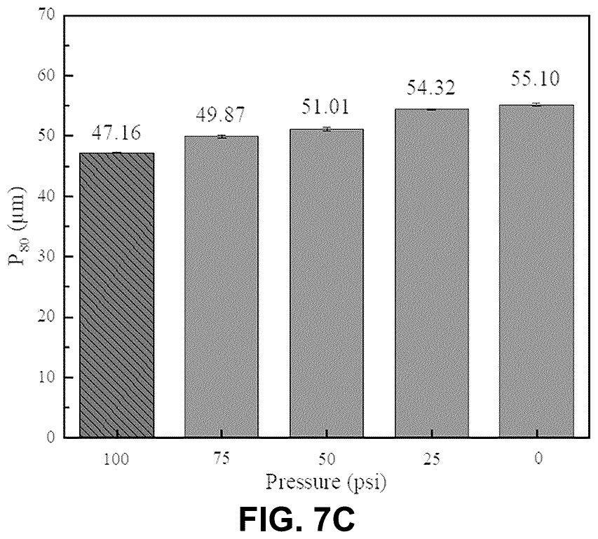

Effect of ex-situ CO₂ treatment pressure on the grindability of bastnaesite: The effect of CO₂ injection pressure on the grindability of bastnaesite was investigated under the conditions of ex-situ CO₂ treatment time of 3 h and pulp concentration of 50%. FIGS. 7A-7C indicate that an increase in CO₂ pressure contributes to the improvement of the grindability of bastnaesite. After the CO₂ pressure increases from 0 psi to 100 psi, the P₈₀ of −75 μm particles decreases from 55.10 μm to 47.16 μm, a decrease of 14.41%.

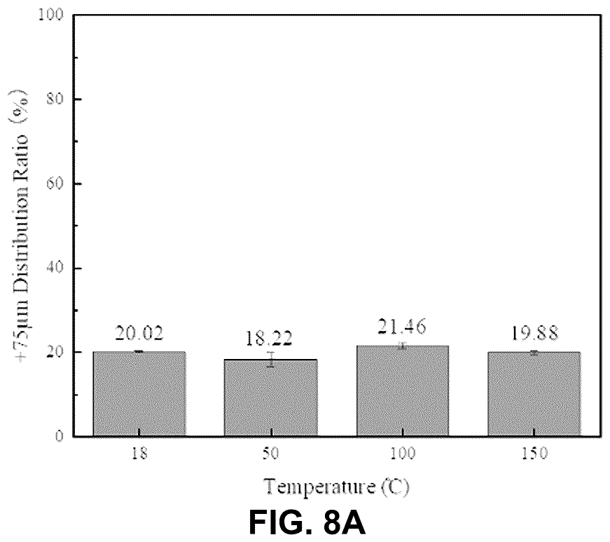

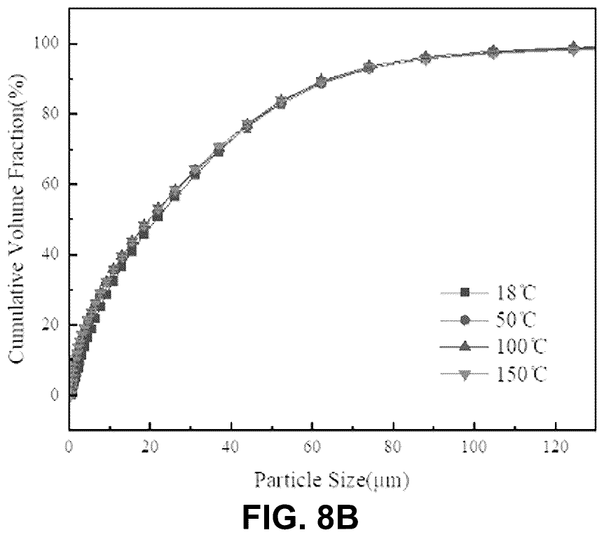

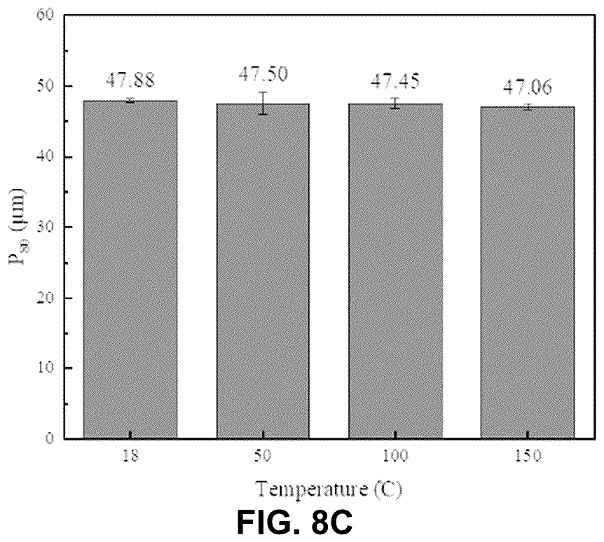

Effect of ex-situ CO₂ treatment temperature on the grindability of bastnaesite: The effect of temperature on the grindability of bastnaesite is investigated under the conditions of ex-situ CO₂ treatment time of 3 h, pressure of 100 psi and pulp concentration of 50%. FIGS. 8A-8C show that the increase in ex-situ CO₂ treatment temperature further improves the grindability of bastnasite. After the treatment temperature is increased from 18° C. to 150° C., the P₈₀ of −75 μm particles is reduced from 47.88 μm to 47.06 μm.

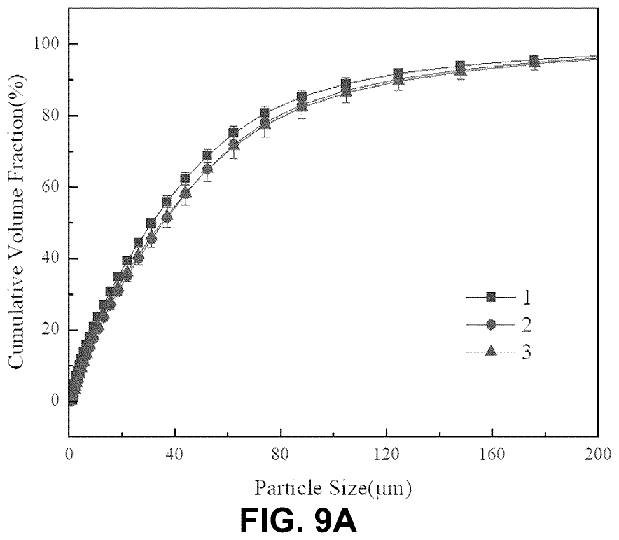

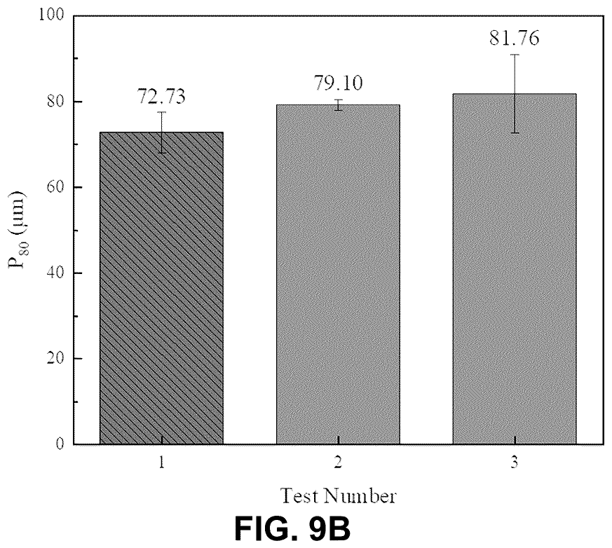

Effectiveness of ex-situ CO₂ treatment in improving the grindability of bastnaesite: Based on the results of the conditional experiments, CO₂ partial pressure of 100 psi, pulp concentration of 50%, duration of 3 h, and room temperature are selected as the conditions for ex-situ CO₂ treatment. Compared with the samples without CO₂ treatment, the effect of ex-situ CO₂ treatment on the grindability of bastnaesite is investigated across full particle sizes. As shown in FIGS. 9A-9B, without any treatment, the grinding product obtained has the coarsest particle size with a P₈₀ of 81.76 μm for full particle sizes. Without CO₂ pressurization, but under other treatment conditions identical to those of ex-situ CO₂ treatment, the P₈₀ of full particle sizes of the grinding product decreases to 79.10 μm. Immersing in water can also slightly improve the grindability of bastnaesite, which can be attributed to the dissolution of soluble minerals in the ore causing the mineral surface to loosen and the ore hardness to decrease. After ex-situ CO₂ treatment, the P₈₀ of the full particle size further drops to 72.73 μm, a reduction of 11.04%, which significantly improved the grindability of bastnaesite. This can be attributed to the fact that in addition to mineral dissolution, CO₂ reacts with certain minerals in the ore, making the mineral surface looser and creating cracks, makes the hardness of the ore even lower.

Ex-Situ CO₂ Treatment—Effect of Ex-Situ CO₂ Treatment on the Grindability of Chalcopyrite

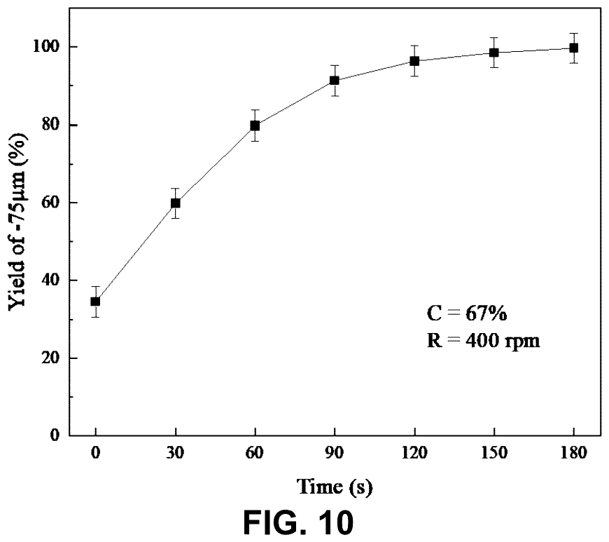

Grinding curve of chalcopyrite: The grinding curve of chalcopyrite is shown in FIG. 10. The planetary mill rotational speed and pulp concentration are also fixed at 400 rpm and 67%, respectively. The yield of −75 μm particles increases with the increase of grinding time. After the grinding time exceeds 120 s, the yield of −75 μm particles exceeds 95% and the increase trend slows down. When the grinding time is 60 s, the yield of −75 μm particles accounts for 79.81%, which is close to industrial production requirements. Therefore, a grinding time of 60 s was selected to study the effect of ex-situ CO₂ treatment on the grindability of chalcopyrite.

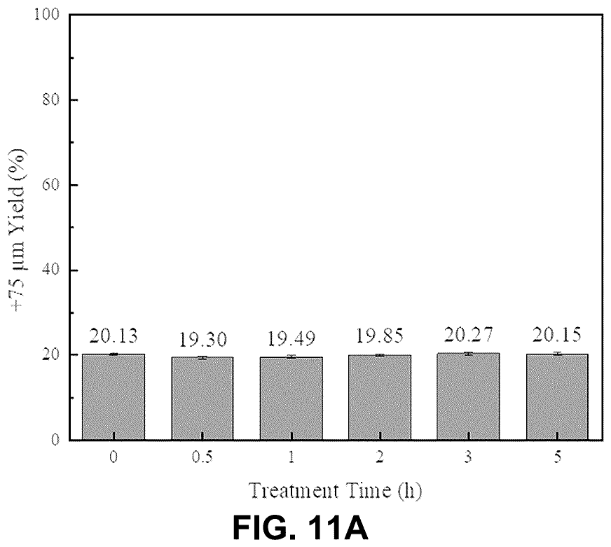

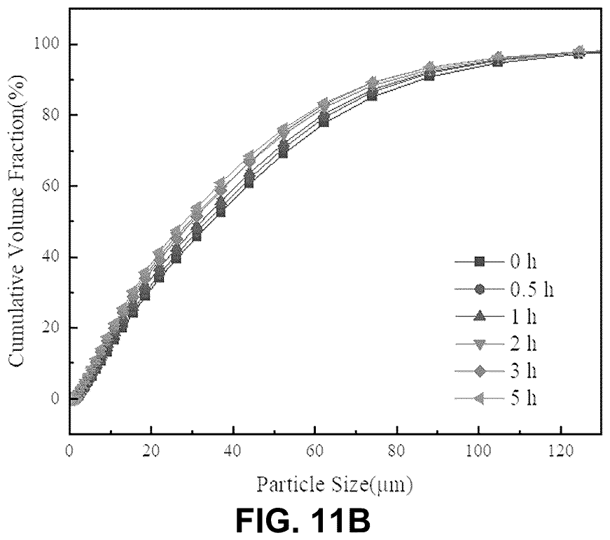

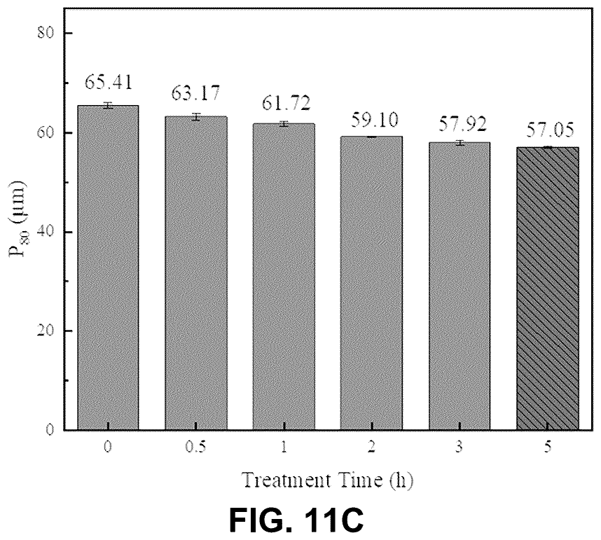

Effect of ex-situ CO₂ treatment time on the grindability of chalcopyrite: Under the conditions of CO₂ pressure of 100 psi, pulp concentration of 50%, and treatment temperature of 21° C., the effect of ex-situ CO₂ treatment time on chalcopyrite particle size distribution was studied. As presented in FIGS. 11A-11C, under the same grinding conditions, extending the ex-situ CO₂ treatment time significantly reduces the size distribution of −75 μm particles compared with no CO₂ treatment. After 5 h of CO₂ ex-situ treatment, the P₈₀ of −75 μm particles dropped from 65.41 μm to a lower value of 57.05 μm, with a decrease of 12.78%. These results confirmed that the grindability of chalcopyrite can also be improved by ex-situ CO₂ treatment. 5 h is selected as the fixed treatment time for subsequent experimental studies of other factors.

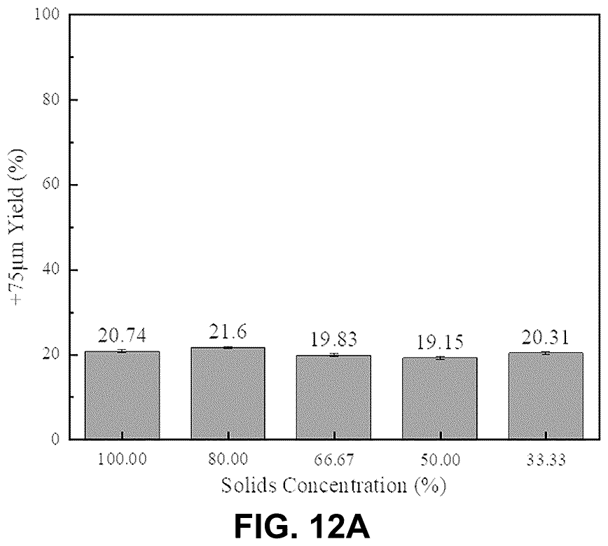

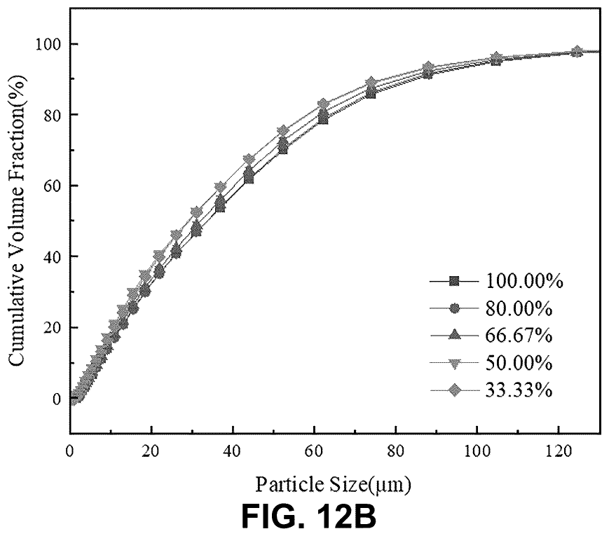

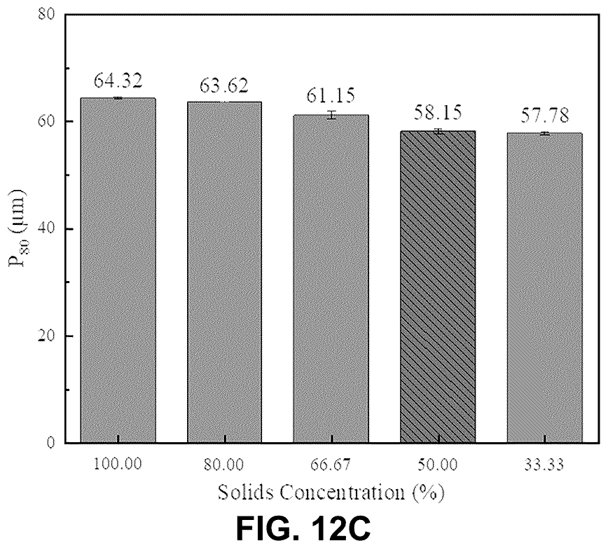

Effect of ex-situ CO₂ treatment pulp concentration on the grindability of chalcopyrite: Under the conditions of a fixed treatment time of 5 h and a constant CO₂ injection pressure of 100 psi, the effect of ex-situ CO₂ treatment pulp concentration on the grindability of chalcopyrite was investigated. As shown in FIGS. 12A-12C, as the pulp concentration decreases, the size distribution of −75 μm particles gradually becomes finer. The presence of water significantly increases the efficiency of ex-situ CO₂ treatment in improving the grindability of chalcopyrite. The P₈₀ of −75 μm particles decreases to 58.15 μm at the pulp concentration of 50% and 57.78 μm at the pulp concentration of 33.33%.

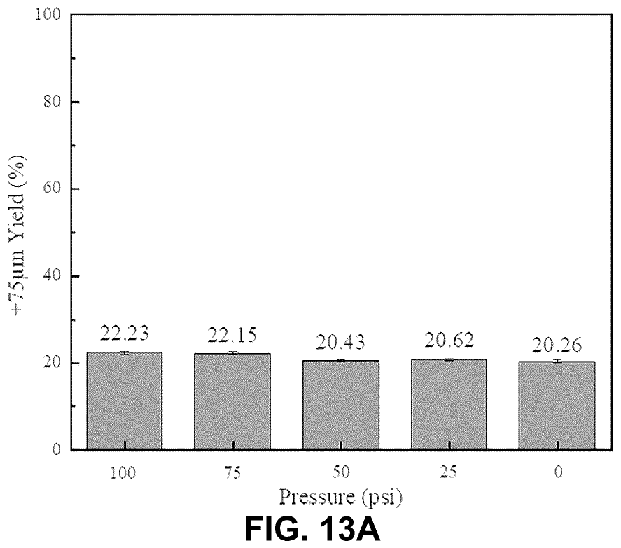

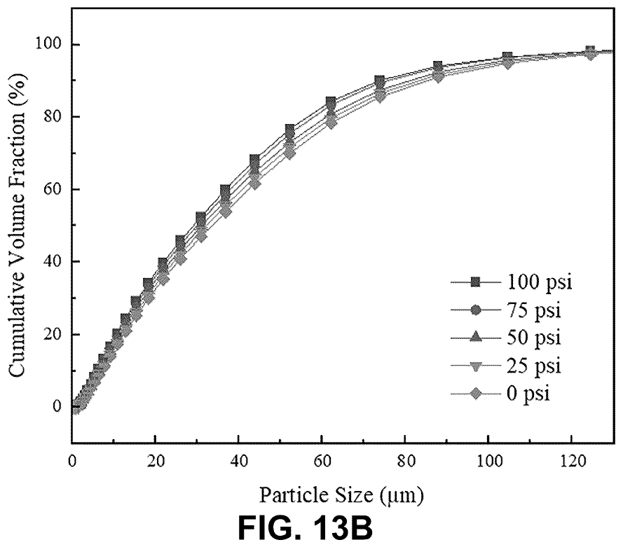

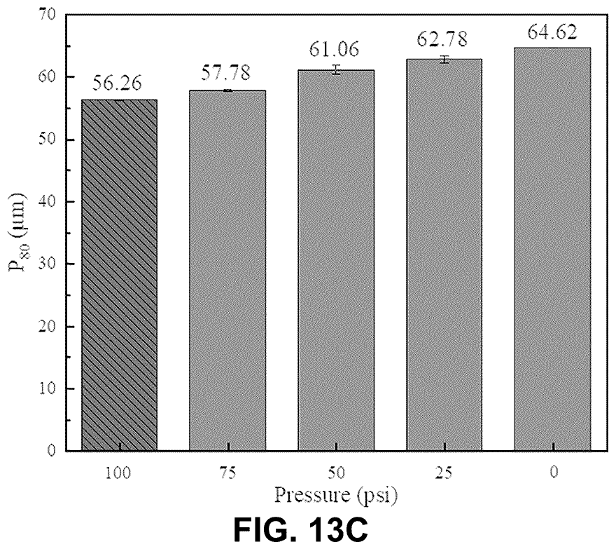

Effect of ex-situ CO₂ treatment pressure on the grindability of chalcopyrite: The effect of CO₂ injection pressure on the grindability of chalcopyrite was investigated under the conditions of ex-situ CO₂ treatment time of 5 h and pulp concentration of 50%. It can be seen from FIGS. 13A-13C that the increase of CO₂ pressure helps to improve the grindability of chalcopyrite. When the CO₂ pressure increases from 0 psi to 100 psi, the P₈₀ of −75 μm particles decreases from 64.62 μm to 56.26 μm, a decrease of 12.93%.

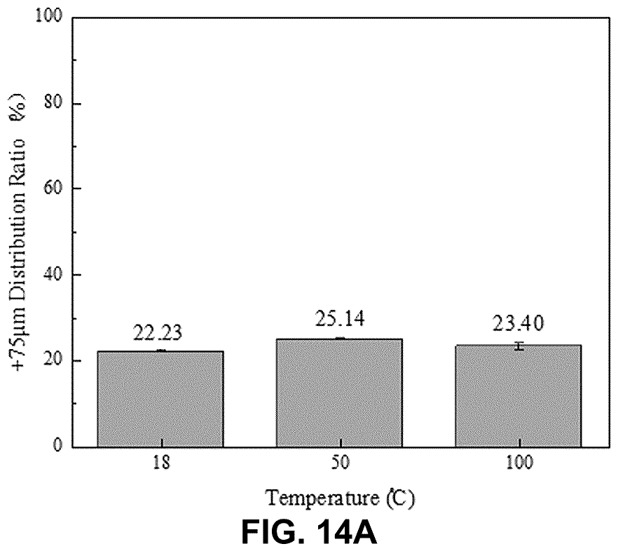

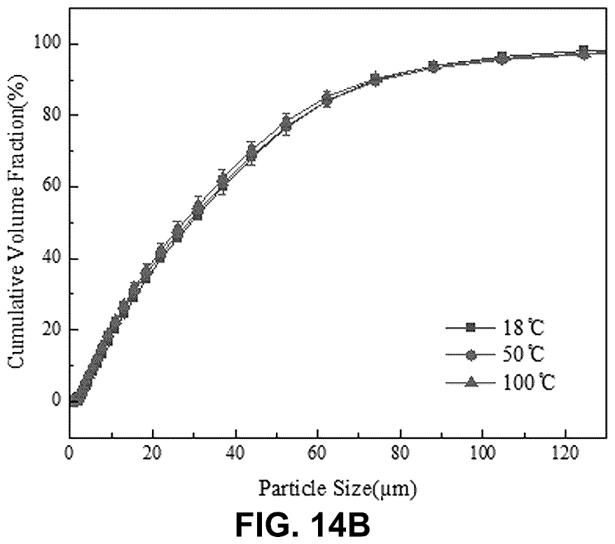

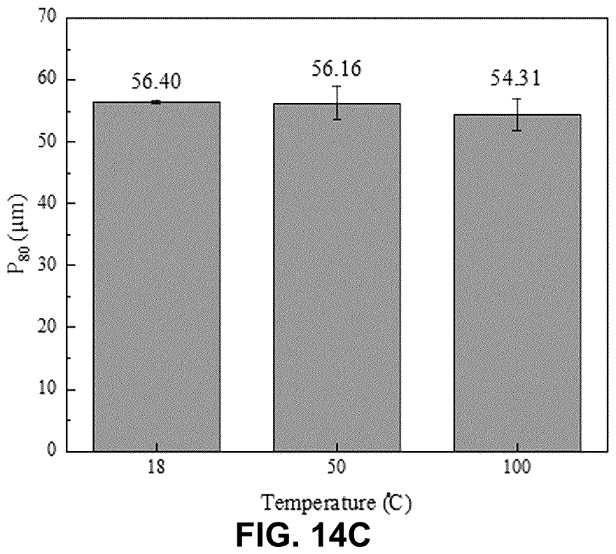

Effect of ex-situ CO₂ treatment temperature on the grindability of chalcopyrite: The impact of temperature on the grindability of chalcopyrite is investigated under the conditions of ex-situ CO₂ treatment for 5 h, at a pressure of 100 psi, and with a pulp concentration of 50%. As seen in FIGS. 14A-14C, the increase in the temperature of ex-situ CO₂ treatment slightly improves the grindability of chalcopyrite. When the treatment temperature is raised from 18° C. to 100° C., the P₈₀ of −75 μm particles decreases from 56.40 μm to 54.31 μm.

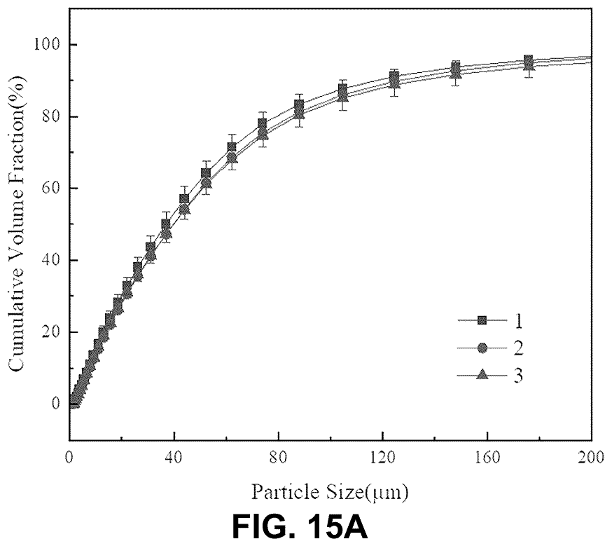

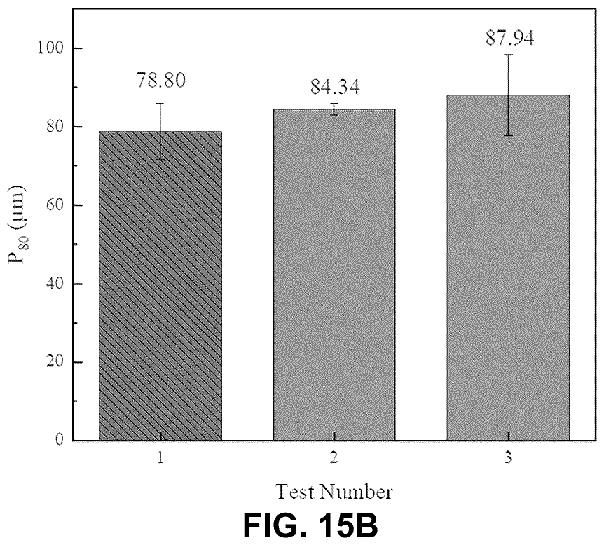

Effectiveness of ex-situ CO₂ treatment in improving the grindability of chalcopyrite: Based on the conclusions of the conditional experiments, CO₂ partial pressure of 100 psi, pulp concentration of 50%, treatment time of 5 h, and room temperature are selected for further studying the effect of ex-situ CO₂ treatment on the grindability of chalcopyrite across full particle sizes. As shown in FIGS. 15A-15B, untreated chalcopyrite yielded a grinding product with a P₈₀ of 87.94 μm for full particle sizes. The P₈₀ of the grinding product of chalcopyrite immersed under the same concentration and time as the ex-situ CO₂ treatment, but without CO₂ pressurization, decreased to 84.34 μm. Immersing in water can also slightly improve the grindability of chalcopyrite, likely also due to the dissolution of soluble minerals in the ore, leading to a loosening of the mineral surfaces and a decrease in ore hardness. After ex-situ CO₂ treatment, the P₈₀ of the grinding product of chalcopyrite decreased further to 78.80 μm, a reduction of 10.39%, significantly enhancing the grindability of chalcopyrite. This mechanism is also related to the dissolution of minerals and their reaction with CO₂.

### Effect of Ex-Situ Supercritical CO₂ Treatment on the Grindability of Bastnasite and Chalcopyrite

When the temperature exceeds 31° C. and the pressure exceeds 1072 psi, CO₂ is in a supercritical state. At this time, CO₂ has dual properties of gas and liquid. Its density is close to that of liquid, its viscosity is close to that of gas, and its diffusion coefficient is nearly a hundred times that of liquid. Based on the above special properties, it is studied whether ex-situ supercritical CO₂ treatment can further improve the grindability of bastnaesite and chalcopyrite. During the treatment process, the pressure and temperature are fixed at 1200 psi and 40° C., respectively.

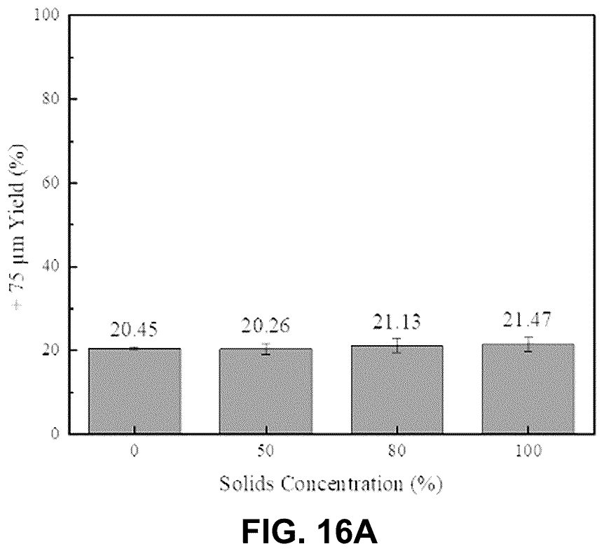

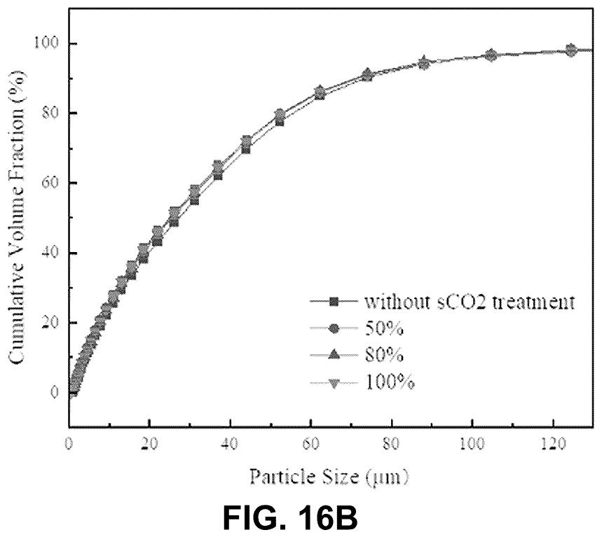

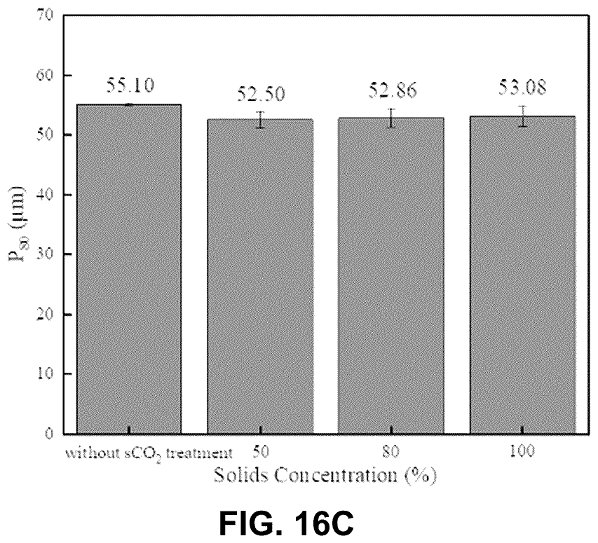

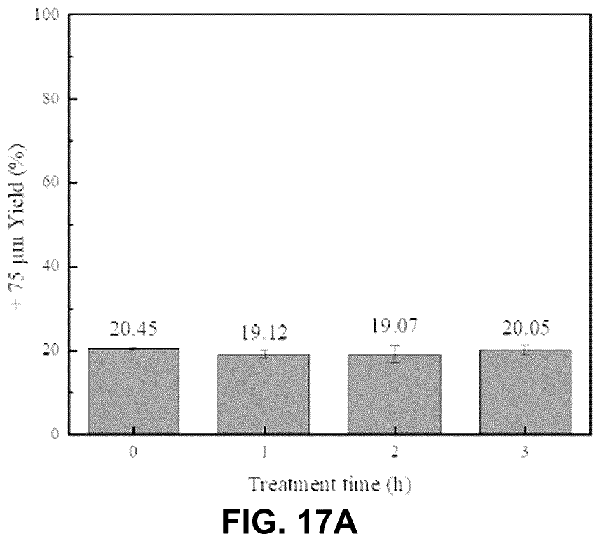

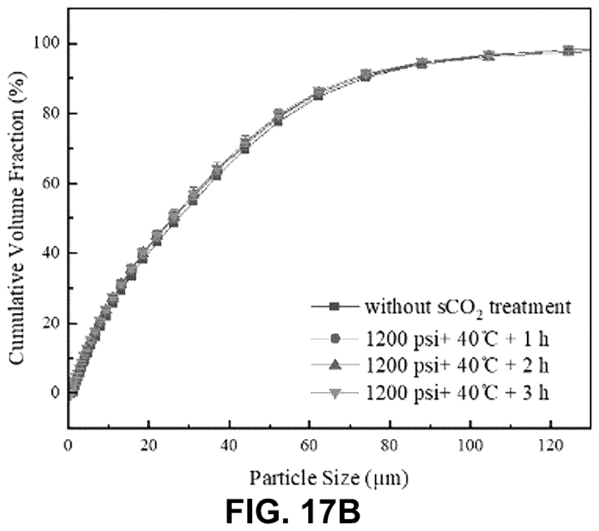

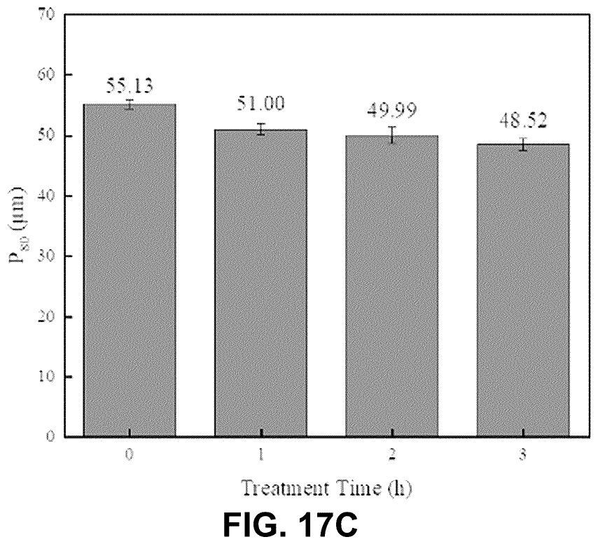

Effect of ex-situ supercritical CO₂ treatment on the grindability of bastnasite: FIGS. 16A-16C and FIGS. 17A-17C respectively show the effect of ex-situ supercritical CO₂ treatment is further improved. When the concentration is 50%, the P₈₀ of −75 μm particle drops to 52.50 μm. Water plays an important role in the reaction of CO₂ with minerals. Prolonging the treatment time also helps to improve the grindability of Bastnaesite. When the treatment time is 3 h, the P₈₀ of −75 μm particle decreases from 55.13 μm to 48.52 μm, a decrease of 11.99%.

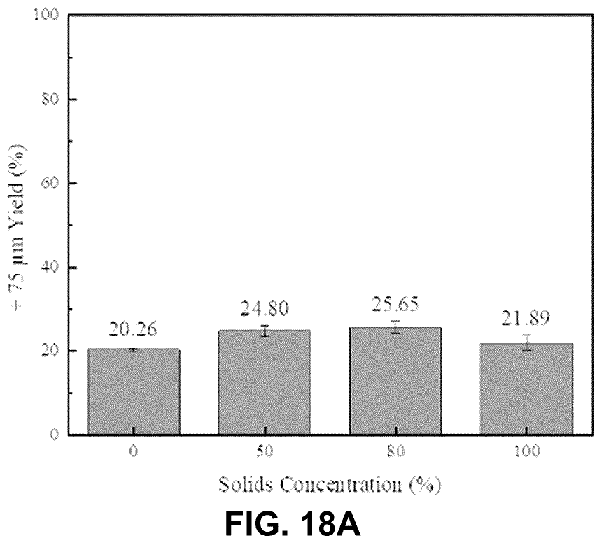

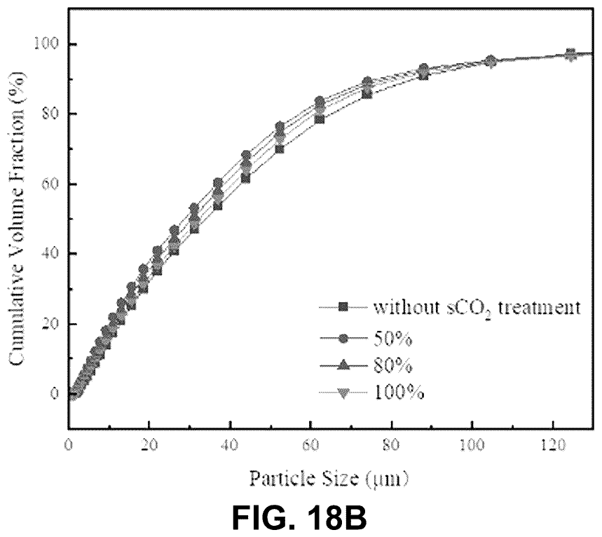

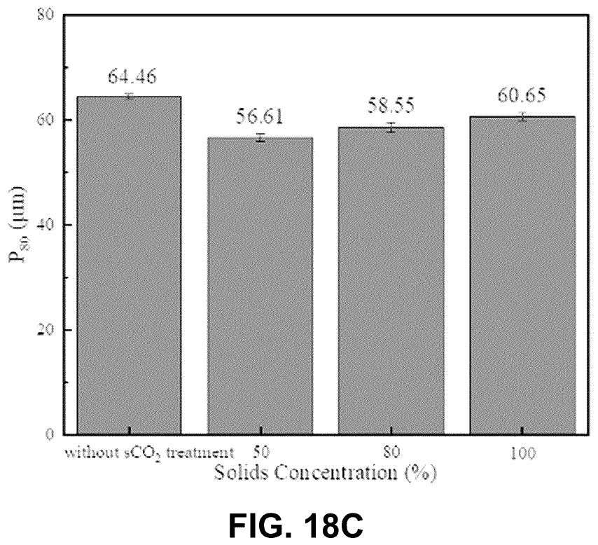

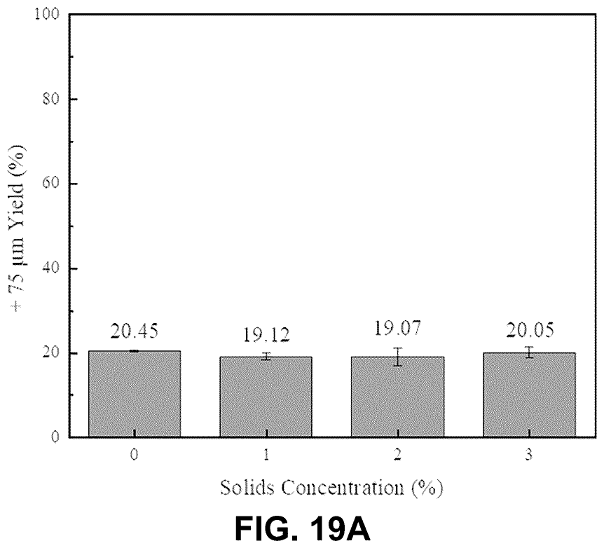

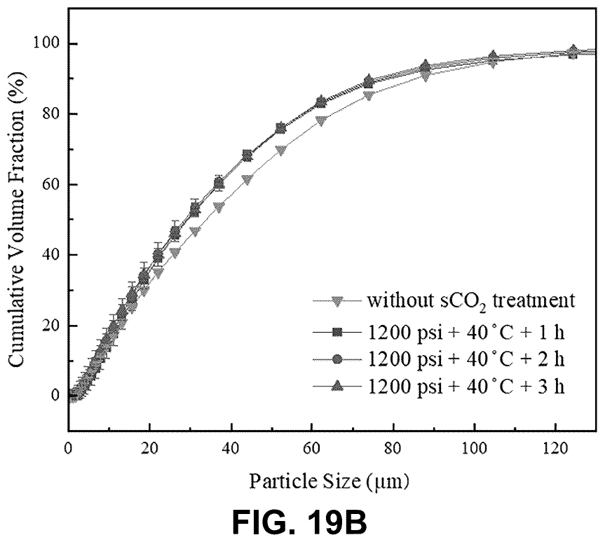

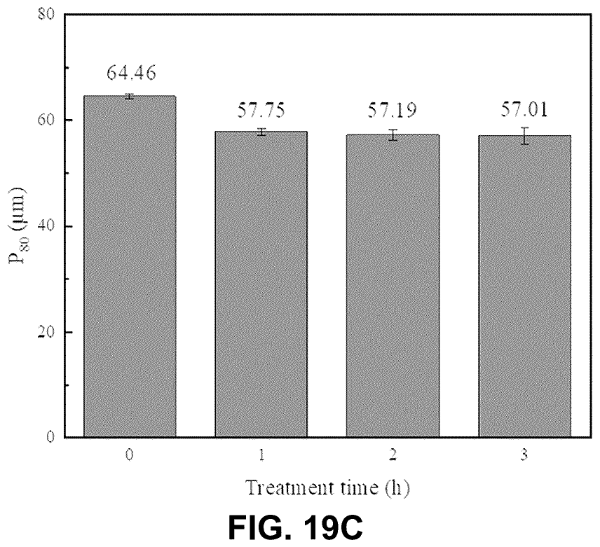

Effect of ex-situ supercritical CO₂ treatment on the grindability of chalcopyrite: FIGS. 18A-18C and FIGS. 19A-19C respectively present the effect of ex-situ supercritical CO₂ treatment on the grindability of chalcopyrite under different pulp concentrations and treatment times. As the concentration decreases, the grindability of chalcopyrite also increases. When the concentration is 50%, the P₈₀ of −75 μm particles drops from 64.46 μm without any treatment to 56.51 μm. After the treatment time reaches 1 h, continuing to increase the treatment time has little effect on improving the grindability of chalcopyrite. The P₈₀ of −75 μm particle size can drop from 64.46 μm without treatment to 57.01 μm after treatment for 3 h, a decrease of 11.56%.

In-Situ CO₂ Treatment—Experimental Method of In-Situ CO₂ Treatment

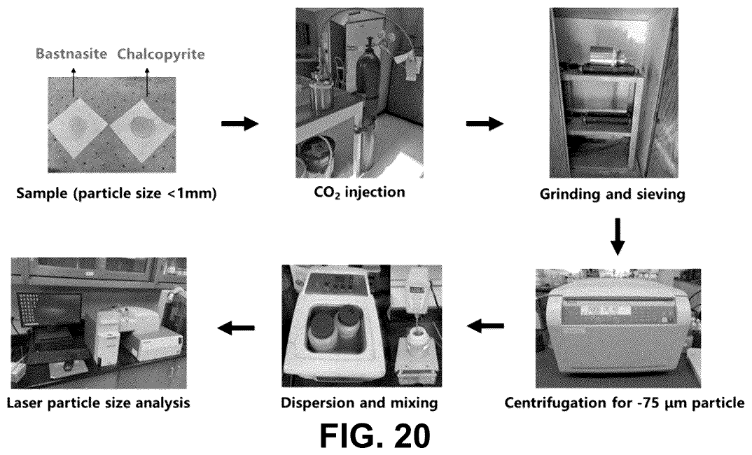

The experimental procedure for evaluating the effect of in-situ CO₂ treatment on grindability of ores is illustrated in FIG. 20. The samples of bastnaesite and chalcopyrite were crushed to −1 mm particle size and homogenized for subsequent testing and analysis. For each test, 200.0 g of the sample and a certain amount of deionized (DI) water are placed into the homemade mill jar, and then CO₂ is injected for 3 min according to the desired partial pressure. After the CO₂ injection is completed, the grinding experiments are carried out on the roller mill. In order to ensure the accuracy of particle size analysis, the ground product is wet-sieved using a 200 mesh (75 μm) sieve. The products above the sieve are filtered and dried to calculate the yield, while the products below the sieve are fully dispersed by adding 10 ml of saturated sodium hexametaphosphate solution and then subjected to particle size distribution using a laser particle size analyzer (Microtrac S3500). Additionally, the particle size distribution of full particle sizes is also measured.

In-Situ CO₂ Treatment—Effect of In-Situ CO₂ Treatment on the Grindability of Bastnaesite

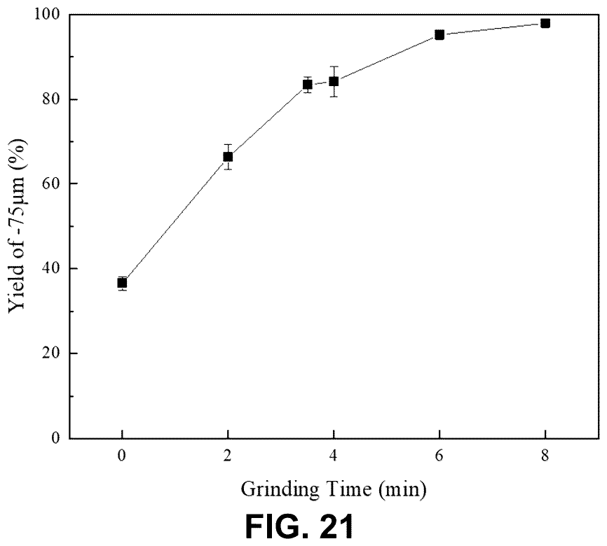

Grinding curve of bastnaesite: To better evaluate the grindability of bastnaesite, it's important to determine a reasonable grinding fineness. The speed of the roller mill is not adjustable. The pulp concentration is fixed at 67%, and the yield of −75 μm particle size is measured at different grinding times. As shown in FIG. 21, the yield of −75 μm particles gradually increases as the grinding time increases. After grinding for more than 6 min, the yield of −75 μm particles reaches over 95%, and the increasing trend slows down. When the grinding time is 3.5 min, the yield of −75 μm particles is 83.38%, which is close to the requirements of actual production. Therefore, the subsequent grinding time is fixed at 3.5 min to study the impact of in-situ CO₂ treatment on the grindability of bastnaesite.

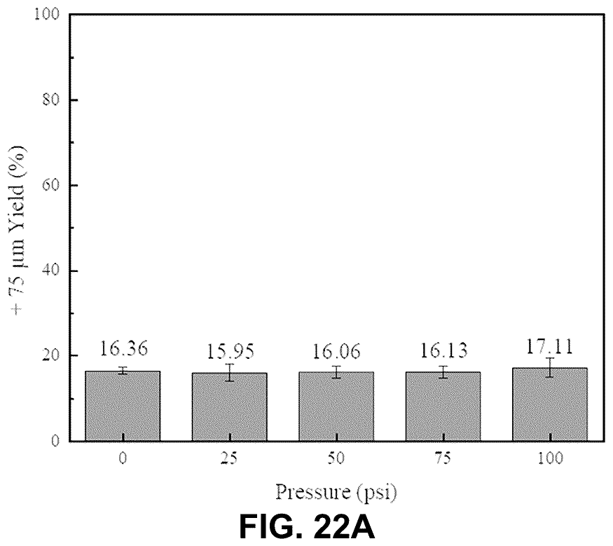

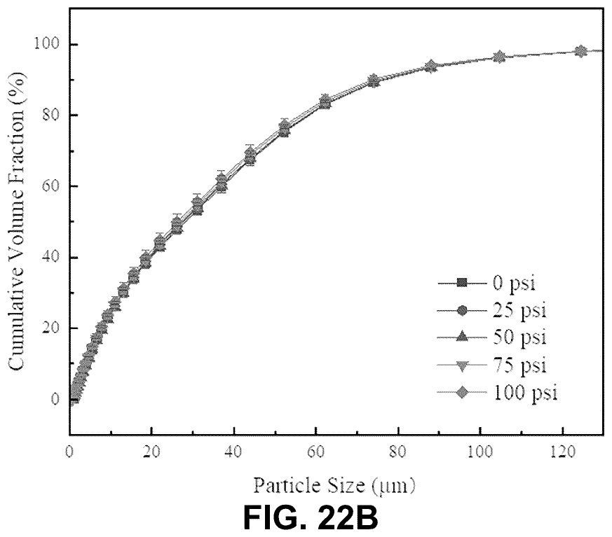

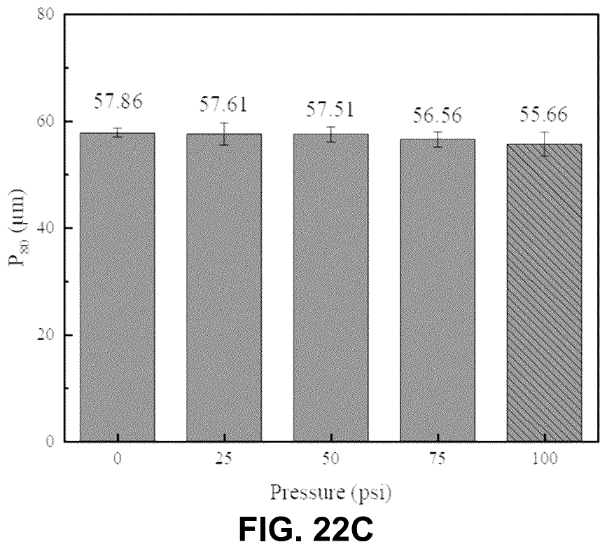

Effect of in-situ CO₂ treatment pressure on the grindability of bastnaesite: Under the conditions of grinding time of 3.5 min and pulp concentration of 67%, the effect of in-situ CO₂ treatment pressure on the grindability of bastnaesite is investigated. FIGS. 22A-22C show that as the CO₂ partial pressure increases during the grinding process, the particle size distribution of bastnaesite becomes finer. When the CO₂ pressure increases from 0 psi to 100 psi, the P₈₀ of −75 μm particles decreases from 57.86 μm to 55.66 μm, with a decrease of 3.80%.

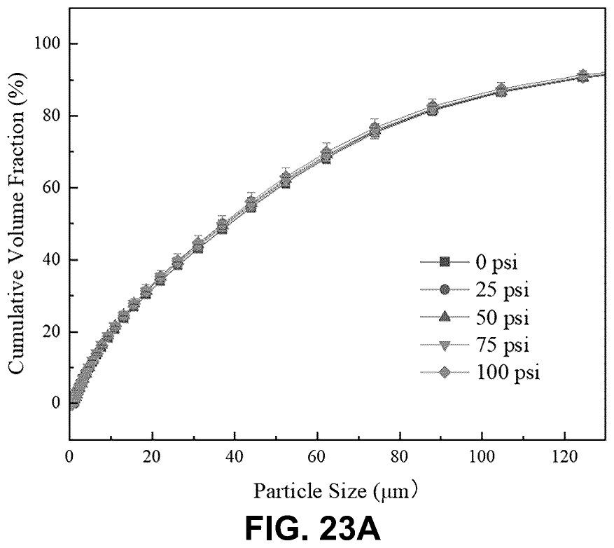

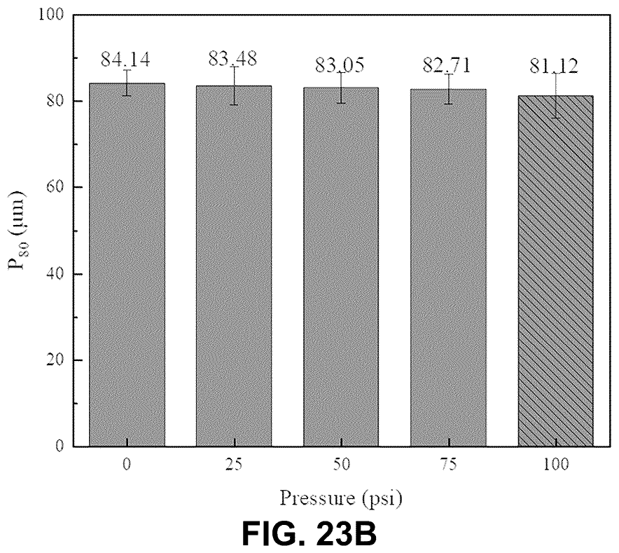

FIGS. 23A-23B describe the distribution of the full particle size under different in-situ CO₂ treatment pressures. Similarly, the fineness of the full particle size gradually decreases with the increase of pressure. When the CO₂ pressure increases from 0 psi to 100 psi, the P₈₀ of full particles decreases from 84.14 μm to 81.12 μm, with a decrease of 3.59%.

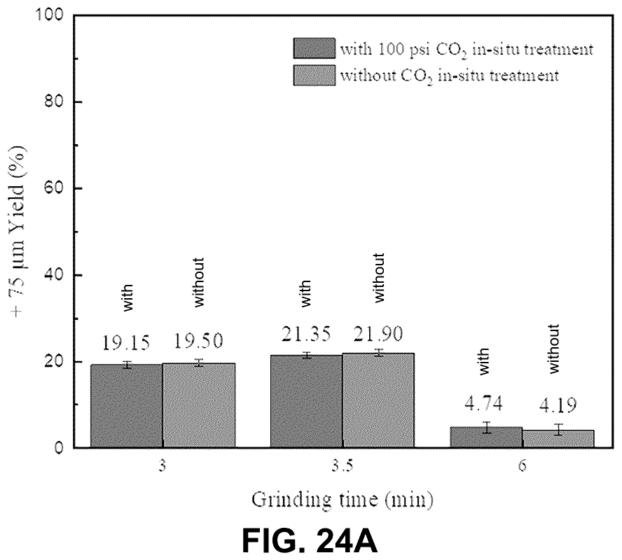

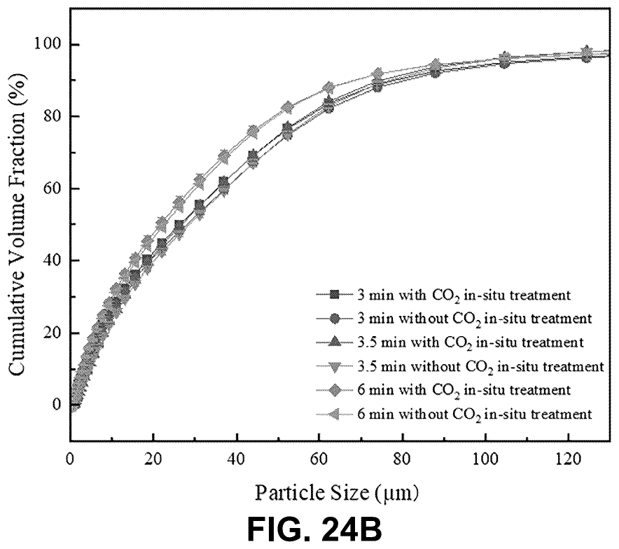

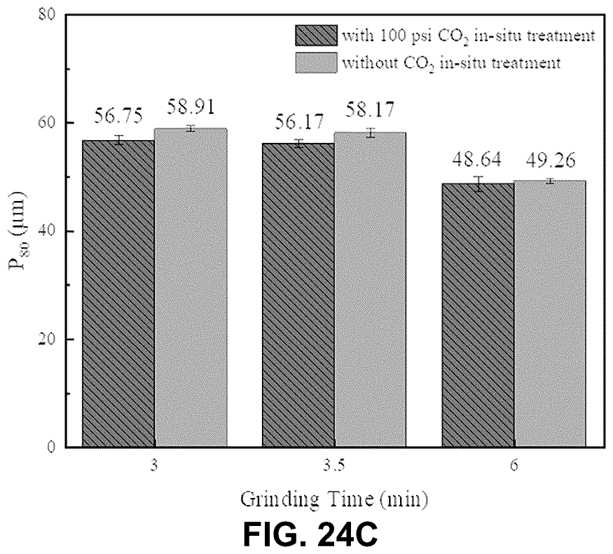

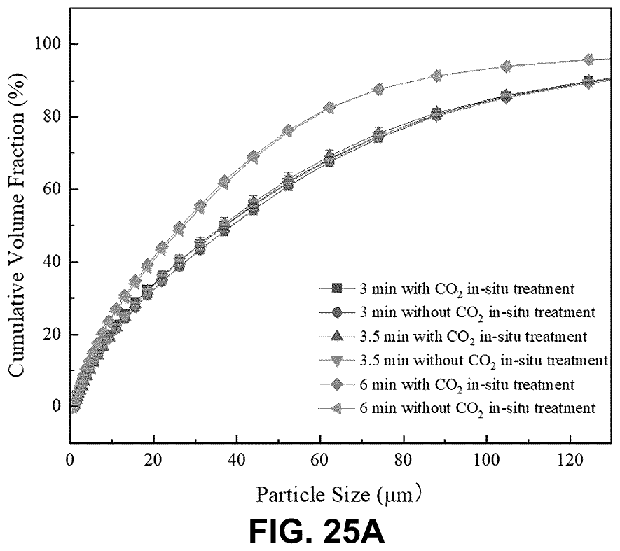

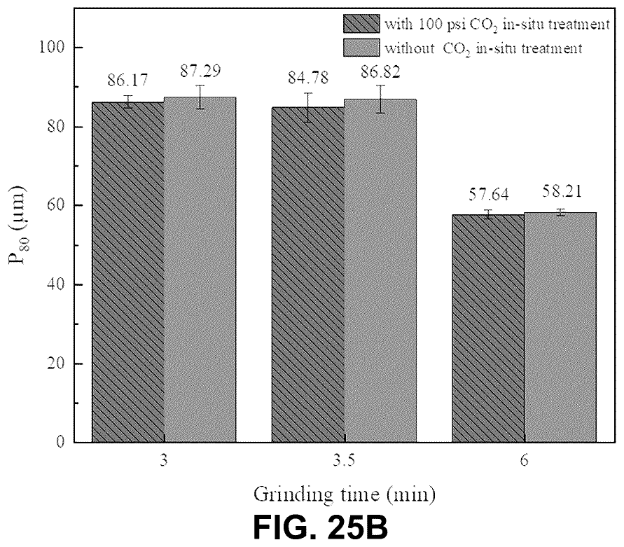

Effectiveness of in-situ CO₂ treatment under different grinding times: The CO₂ partial pressure is fixed at 100 psi, and the pulp concentration is fixed at 67%, the grinding-aiding effect of in-situ CO₂ treatment on bastnaesite under different grinding times is studied. FIGS. 24A-24C and FIGS. 25A-25B show the −75 μm and full particle size distributions under different grinding times. As the grinding time increases, the particle size distribution of the grinding products with in-situ CO₂ treatment and without CO₂ treatment shows a downward trend. Under the same grinding time, the particle size distribution of samples with in-situ CO₂ treatment is lower than that without in-situ CO₂ treatment. After in-situ CO₂ treatment, when the grinding time is 3 min, 3.5 min and 6 min, the P₈₀ of the full particle size decreases by 1.12 um, 2.04 μm and 0.57 μm, respectively.

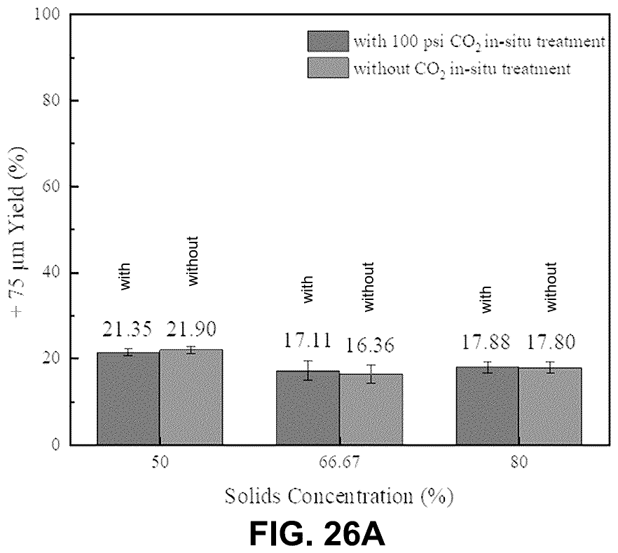

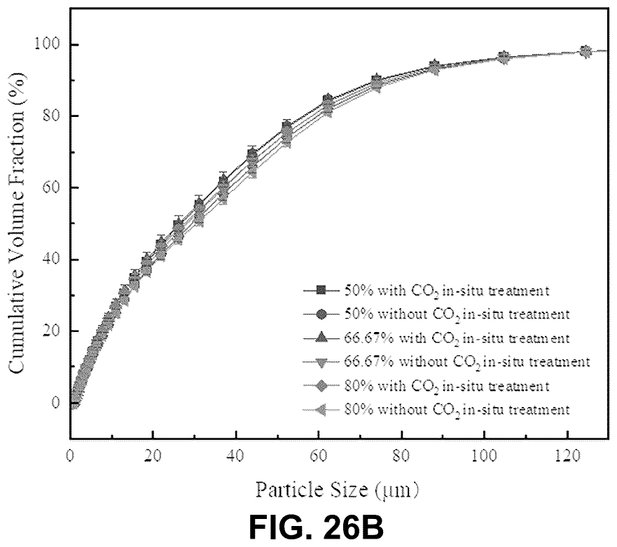

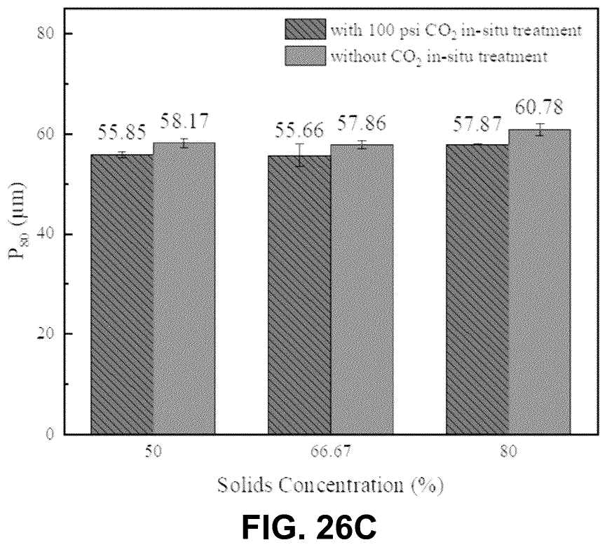

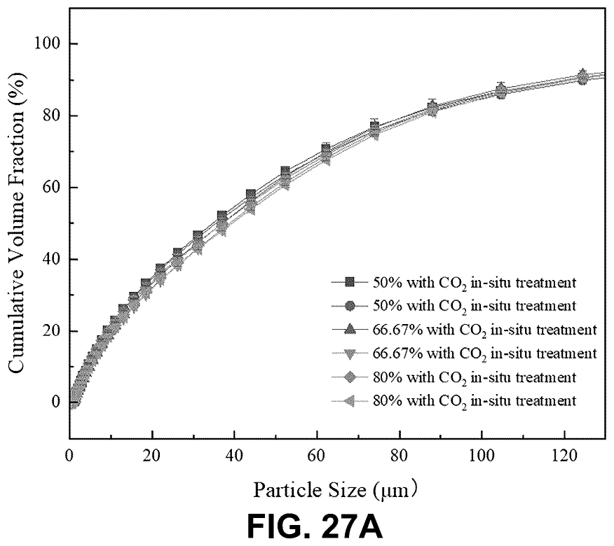

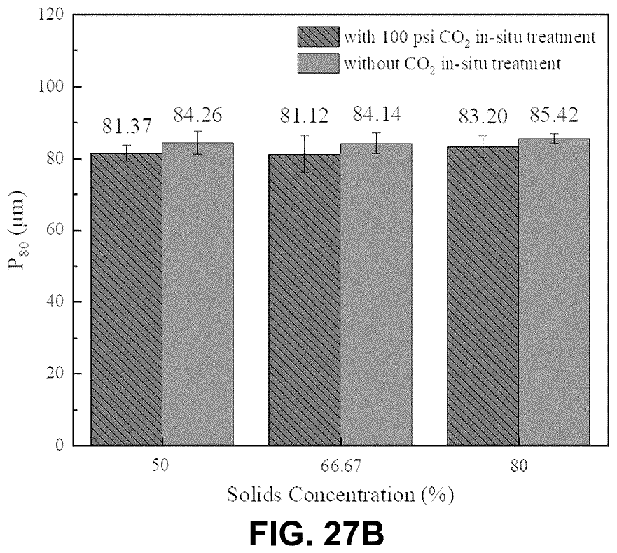

Effectiveness of in-situ CO₂ treatment under different pulp concentrations: The CO₂ partial pressure is fixed at 100 psi, and the grinding time is fixed at 3.5 min, and the grinding-aiding effect of in-situ CO₂ treatment on bastnaesite is studied under different pulp concentrations. FIGS. 26A-26C to FIGS. 27A-27B present the −75 μm and full particle size distributions under different grinding times. The particle size distribution of the samples with in-situ CO₂ treatment is consistently lower than that without in-situ CO₂ treatment. As the concentration increases, the yield of the −75 μm particle size first decreases and then increases, indicating that excessively high or low slurry concentrations are not conducive to ensuring grinding efficiency. After in-situ CO₂ treatment, when the pulp concentration is 50%, 67% and 80%, the P₈₀ of the full particle size decreases by 2.89 μm, 3.02 μm and 2.22 μm, respectively.

In-Situ CO₂ Treatment—Effect of In-Situ CO₂ Treatment on the Grindability of Chalcopyrite

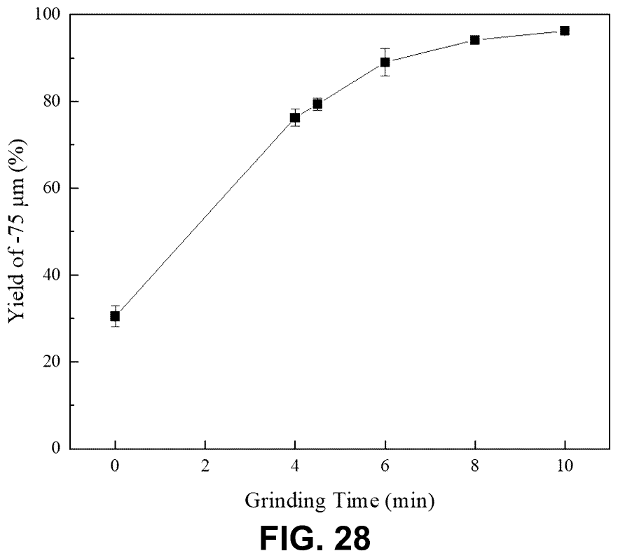

Grinding curve of chalcopyrite: The speed of the roller mill is fixed, and the pulp concentration is set at 67%. The yield of −75 μm particles is measured at different grinding times. As shown in FIG. 28, the yield of −75 μm particles gradually increases with the grinding time increases. After more than 8 min, the yield of −75 μm particles exceeds 95%, and the rate of increase begins to slow down. When the grinding time reaches 4.5 min, the yield of −75 μm particles is 79.37%, which is close to the requirements of actual production. Therefore, subsequent experiments will maintain a grinding time of 3.5 min to study the impact of in situ-CO₂ treatment on the grindability of chalcopyrite.

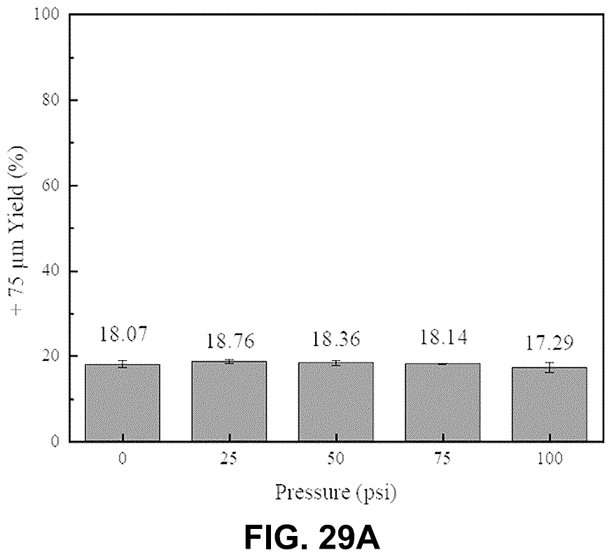

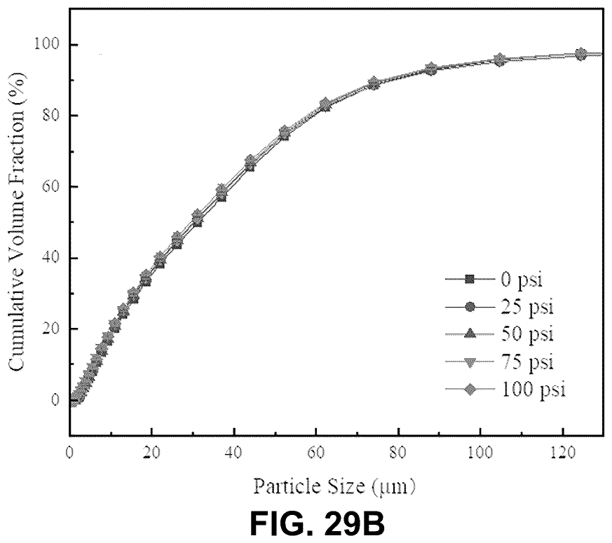

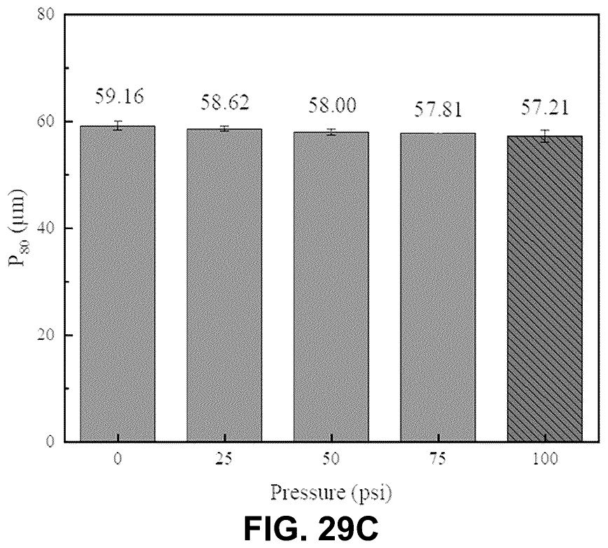

Effect of in-situ CO₂ treatment pressure on the grindability of chalcopyrite: Under the conditions of grinding time of 4.5 min and pulp concentration of 67%, the effect of in-situ CO₂ treatment pressure on the grindability of chalcopyrite is investigated. As shown in FIGS. 29A-29C, as the CO₂ partial pressure increases, the particle size distribution of chalcopyrite becomes finer. When the CO₂ pressure increases from 0 psi to 100 psi, the P₈₀ of −75 μm particles decreases from 59.16 μm to 57.21 μm, a decrease of 3.30%.

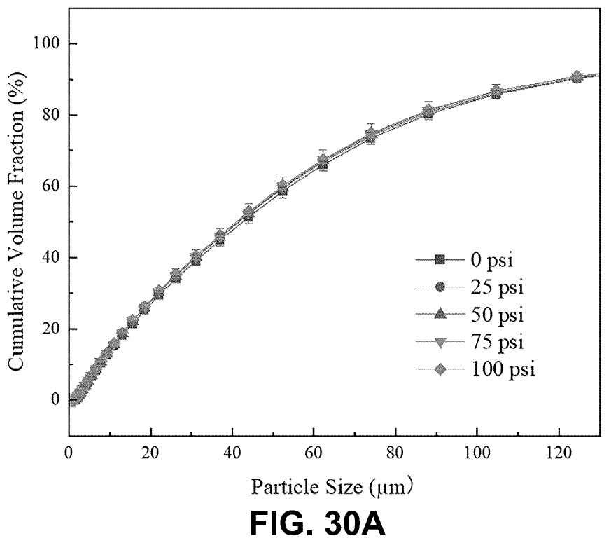

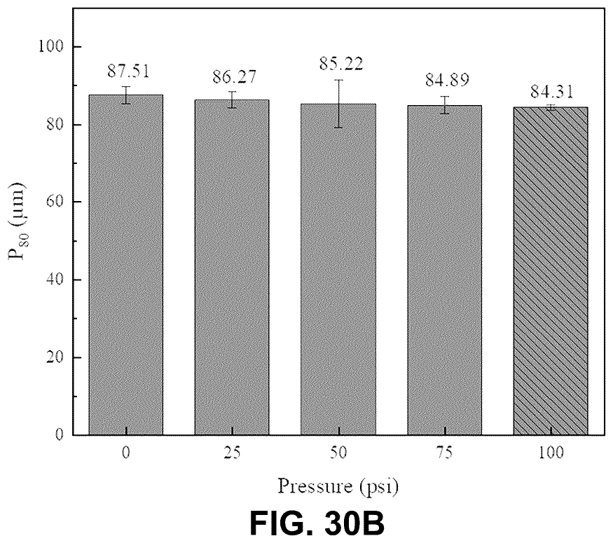

FIGS. 30A-30B describe the distribution of the full particle size under different in-situ CO₂ treatment pressures. The fineness of the full particle size gradually decreases with the increase of pressure. When the CO₂ pressure increases from 0 psi to 100 psi, the P₈₀ of full particles decreases from 87.51 μm to 84.31 μm, with a decrease of 3.66%.

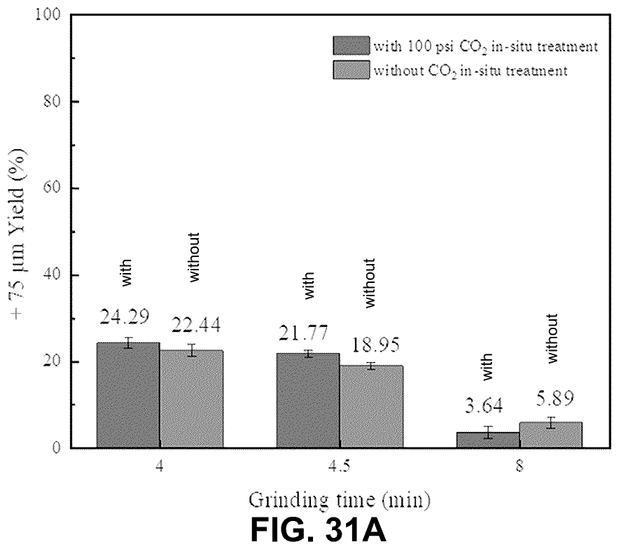

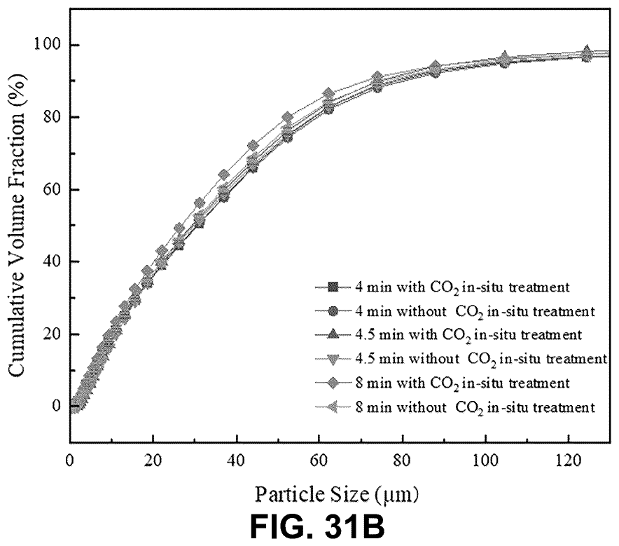

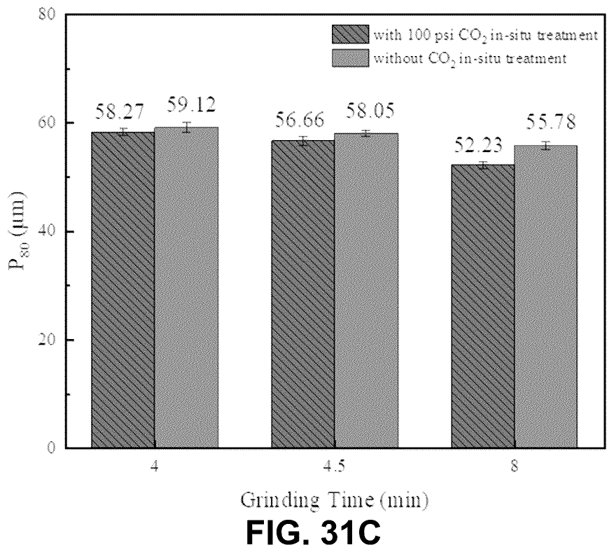

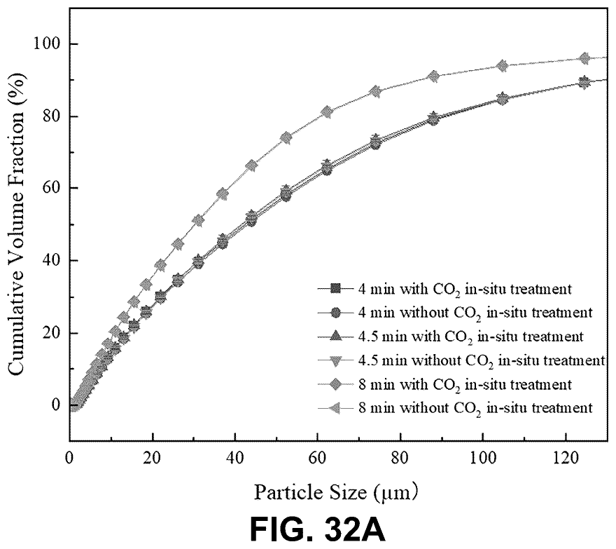

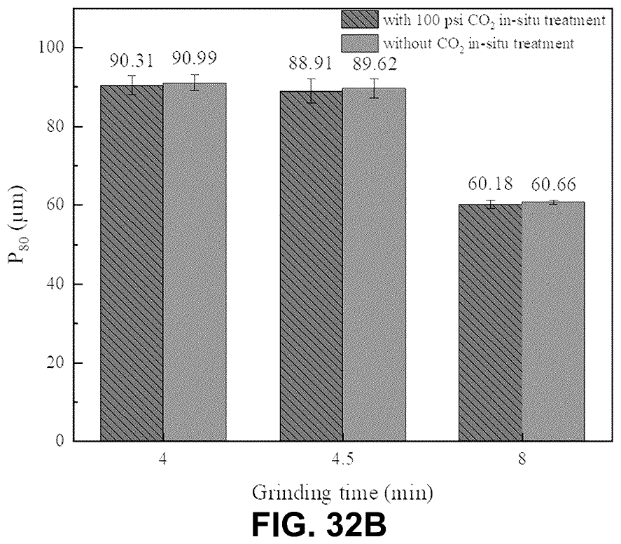

Effectiveness of in-situ CO₂ treatment under different grinding times: The CO₂ partial pressure is fixed at 100 psi and the pulp concentration is fixed at 67%, the grinding-aiding effect of in-situ CO₂ treatment on chalcopyrite under different grinding times is studied. FIGS. 31A-31C to FIGS. 32A-32B show the −75 μm and full particle size distributions. The particle size distribution treated with in-situ CO₂ is lower than that without in-situ CO₂ treatment. As the grinding time increases, the particle size distributions with in-situ CO₂ treatment and without CO₂ treatment both show a downward trend. When the grinding time is 4 min, 4.5 min and 8 min, the P₈₀ of full particle size decreases by 0.68 μm, 0.71 μm and 0.48 μm respectively.

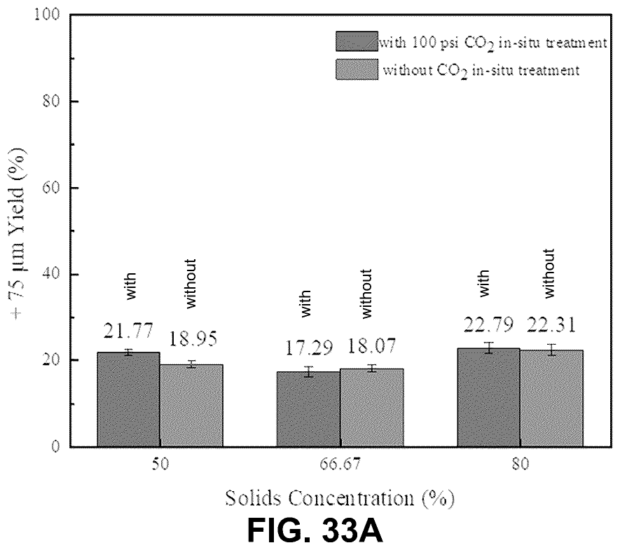

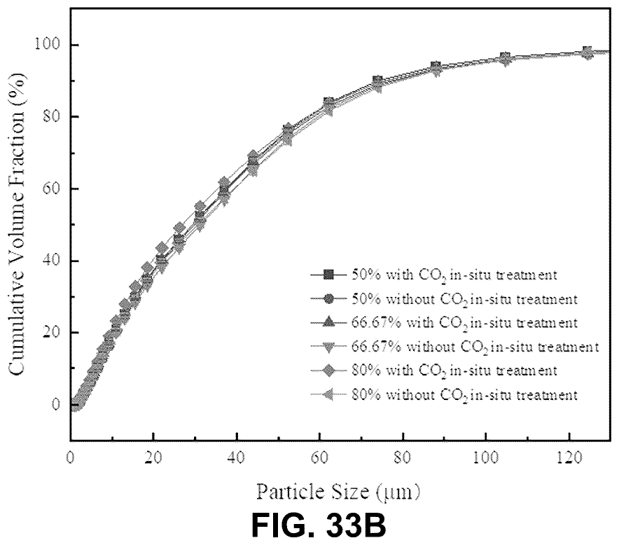

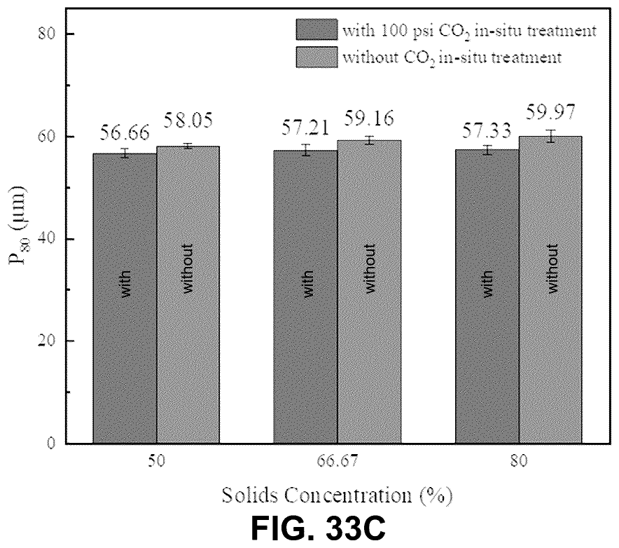

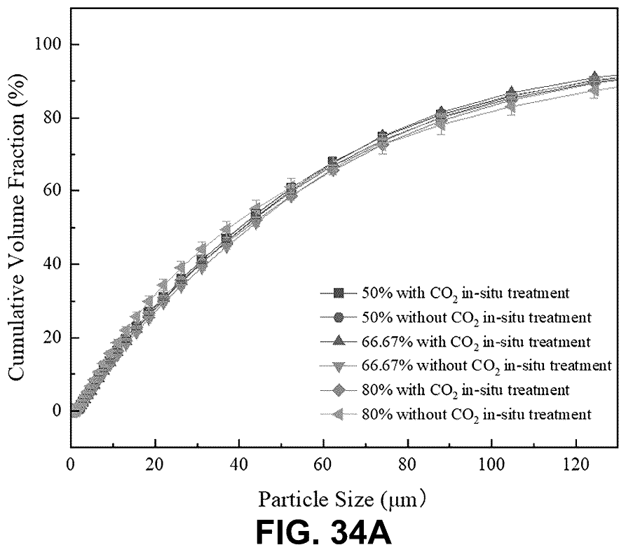

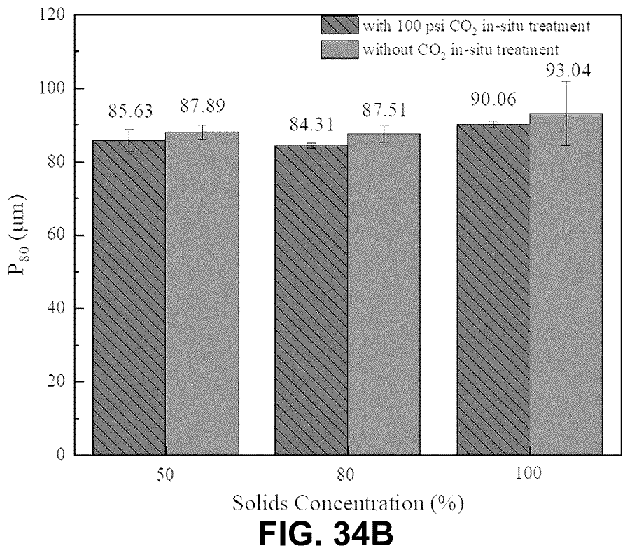

Effectiveness of in-situ CO₂ treatment under different pulp concentrations: The CO₂ partial pressure is fixed at 100 psi, and the grinding time is fixed at 4.5 min, and the grinding-aiding effect of in-situ CO₂ treatment on chalcopyrite is studied under different pulp concentrations. FIGS. 33A-33C to FIGS. 34A-34B show the −75 μm and full particle size distributions at different grinding times. Under the same pulp concentration, the particle size distribution of samples treated with in-situ CO₂ is always lower than that of samples without in-situ CO₂ treatment. As the concentration increases, the yield of −75 μm particle size also first decreases and then increases, indicating that appropriate pulp concentration can ensure grinding efficiency. After in-situ CO₂ treatment, when the pulp concentration is 50%, 67% and 80%, the P₈₀ of full particle size decreases by 2.26 μm, 3.20 μm and 2.98 μm respectively.

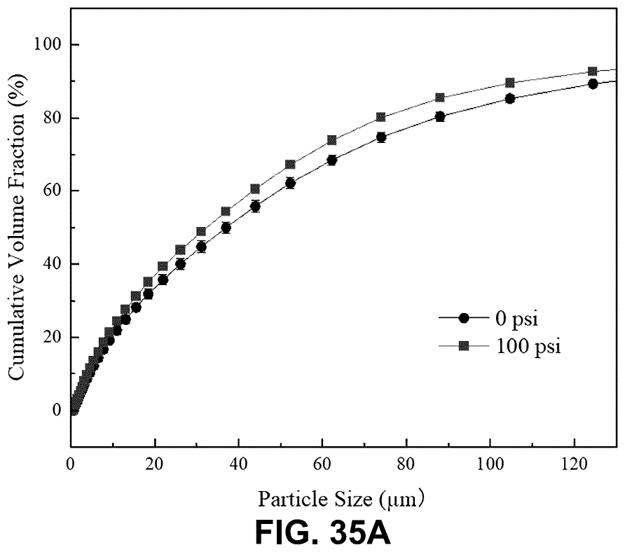

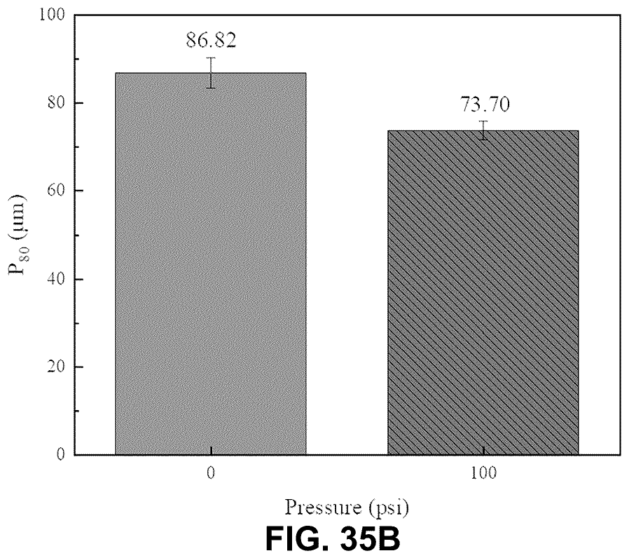

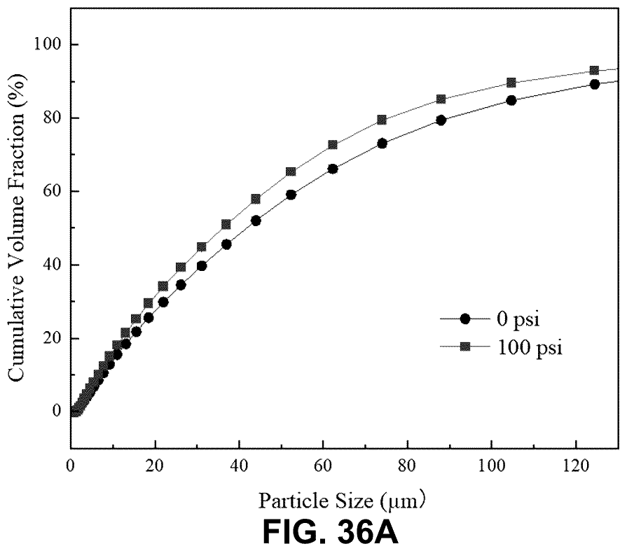

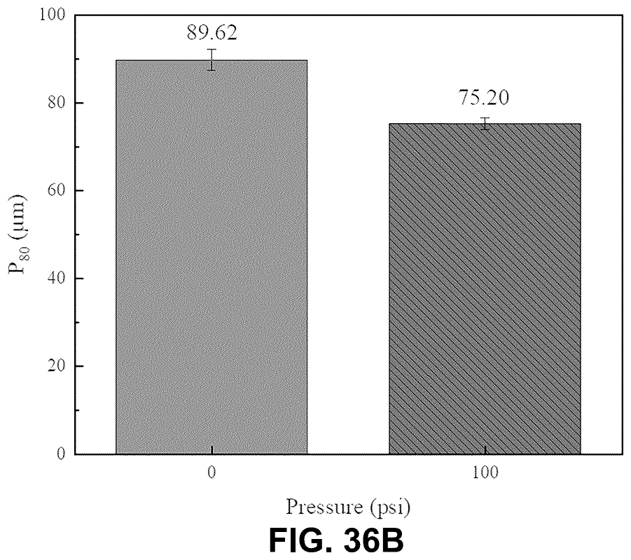

Ex-situ CO₂+in-situ CO₂ treatment. Ex-situ CO₂ treatment and in-situ CO₂ treatment demonstrated the effect of improving the grindability of bastnaesite and chalcopyrite respectively. On the basis of conditional experiments, the effects of the combination of ex-situ CO₂ treatment and in-situ CO₂ treatment on the grindability of bastnaesite and Chalcopyrite are further studied. The raw ore treated with ex-situ CO₂ is dried at low temperature and then ground in a jar mill. The experimental conditions are shown in Table 1, and the experimental results are shown in FIGS. 35A-35B and FIGS. 36A-36B.

TABLE 1
Experimental conditions of ex-situ CO₂ + in-situ CO₂ treatment.

| | Conditions of ex-situ CO₂ | Conditions of in-situ CO₂ |
|---|---|---|
| | treatment | treatment (Grinding) |
| Bastnaesite | CO₂ partial pressure of 100 | CO₂ partial pressure of 100 |
| | psi, duration of 3 h, pulp | psi, duration of 3.5 min, pulp |
| | concentration of 50% | concentration of 67% |
| Chalcopyrite | CO₂ partial pressure of 100 | CO₂ partial pressure of 100 |
| | psi, duration of 5 h, pulp | psi, duration of 4.5 min, pulp |
| | concentration of 50% | concentration of 67% |

The particle size distribution data reveals that the combined application of ex-situ and in-situ CO₂ treatments further enhances the grindability of bastnaesite and chalcopyrite, especially by significantly reducing the proportion of coarse particles in the grinding products. The P₈₀ of the bastnaesite decreases from 86.82 μm to 73.70 μm, a reduction of 15.11%, while the P₈₀ of the chalcopyrite decreases from 89.62 μm to 75.20 μm, a reduction of 16.09%.

### F. EXAMPLE 2

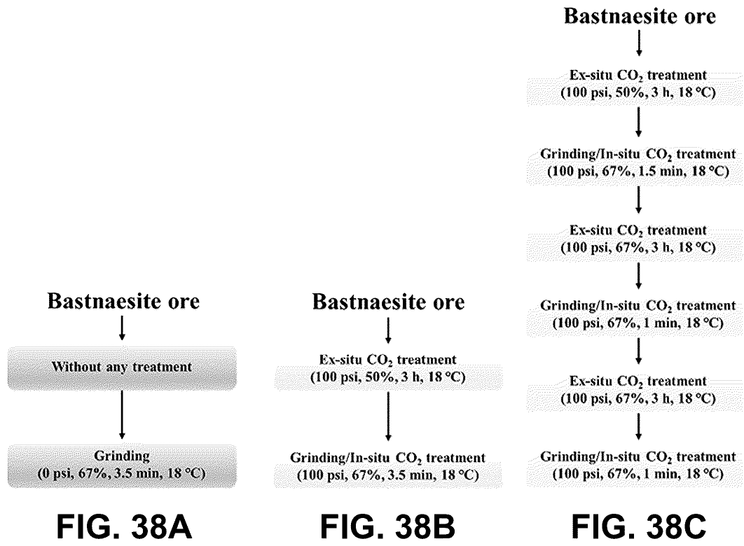

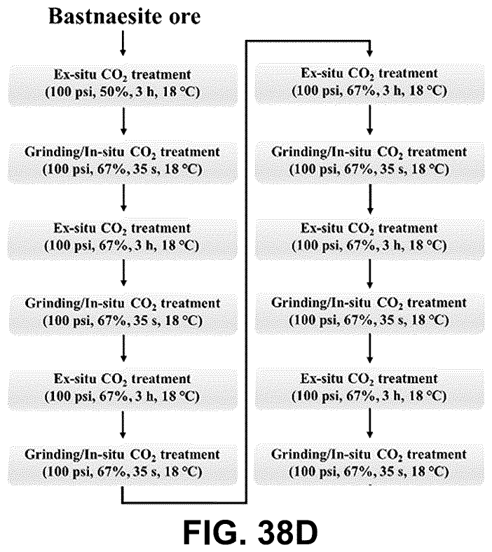

Stepwise CO₂ treatment and stepwise grinding. Under a CO₂ partial pressure of 100 psi, the combination of ex-situ and in-situ CO₂ treatment exhibited a good grinding aid effect. However, none of increasing the CO₂ partial pressure, raising the temperature, nor adding a buffer could further improve the grinding aid effect. Without wishing to be bound by theory, it is considered that CO₂ only reacts with the surface of the ore and forms a passivation layer that hinders the reaction from proceeding into the interior of the ore. Therefore, a process involving stepwise CO₂ treatment and stepwise grinding could aid in further improving the grindability of the ore. Herein are provided comparisons without any treatment and ex-situ+in-situ CO₂ treatment to evaluate the effect of stepwise treatment. The test conditions are shown in FIGS. 38A-38D.

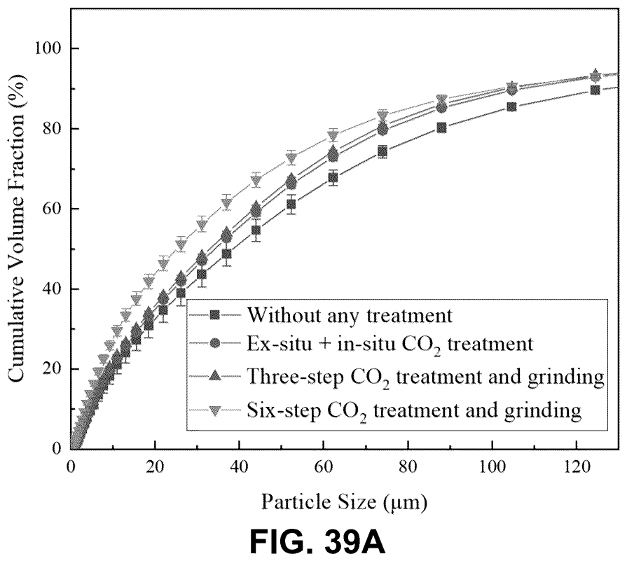

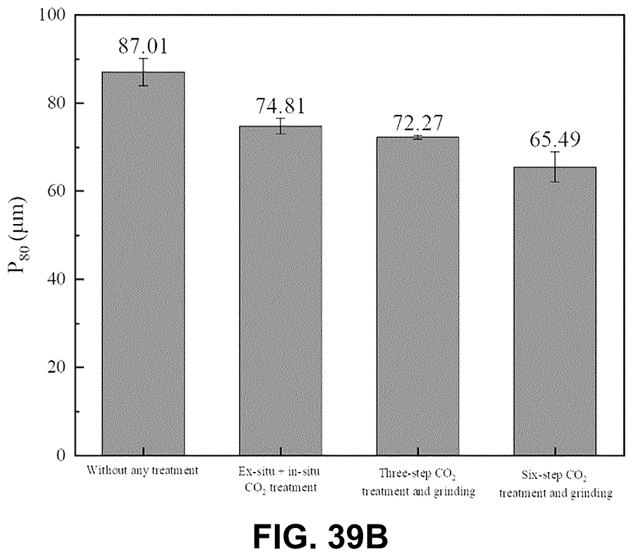

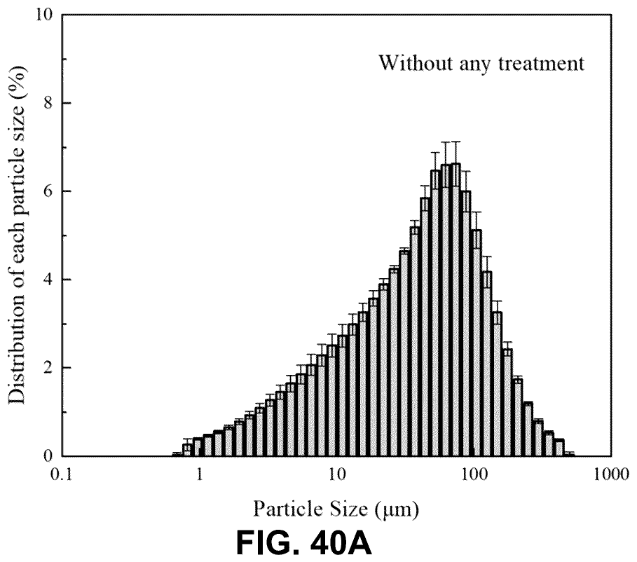

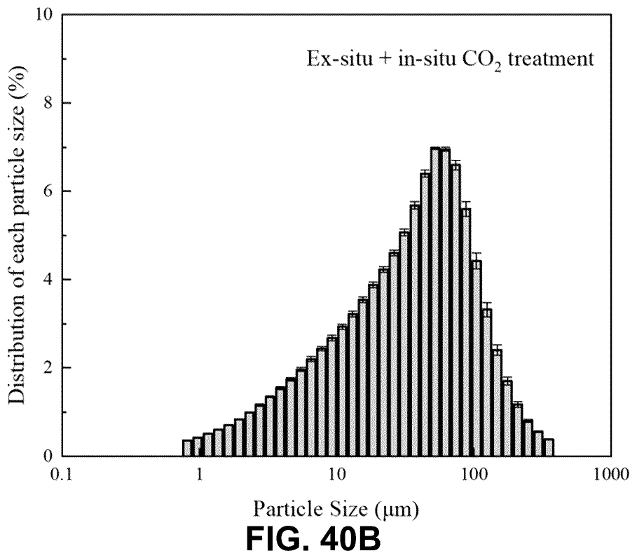

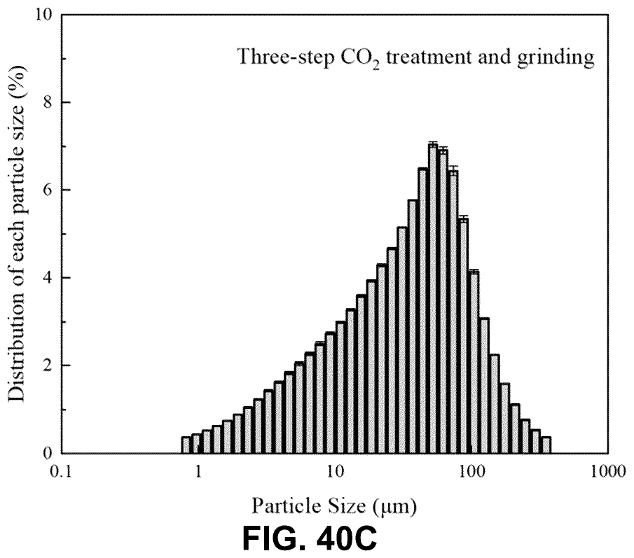

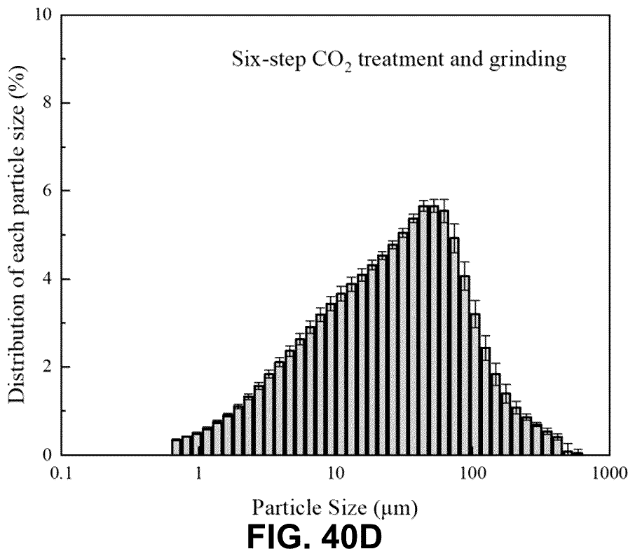

As shown in FIGS. 39A-39B, without any treatment, the P₈₀ of the full particle size of the bastnaesite is 87.01 μm. After the ex-situ+in-situ CO₂ treatment, the P₈₀ drops to 74.81 μm. After conducting the CO₂ treatment and grinding in three steps and six steps, the P₈₀ further decreases to 72.27 μm and 65.49 μm, respectively. This indicates that the stepwise treatment allows CO₂ to react with more mineral surfaces, which can improve the grindability of bastnaesite ore. Additionally, a greater number of processing steps means that CO₂ reacts more thoroughly with the ore, resulting in a more significant reduction in the ore's hardness. The detailed distribution of each particle size is shown in FIGS. 40A-40D.

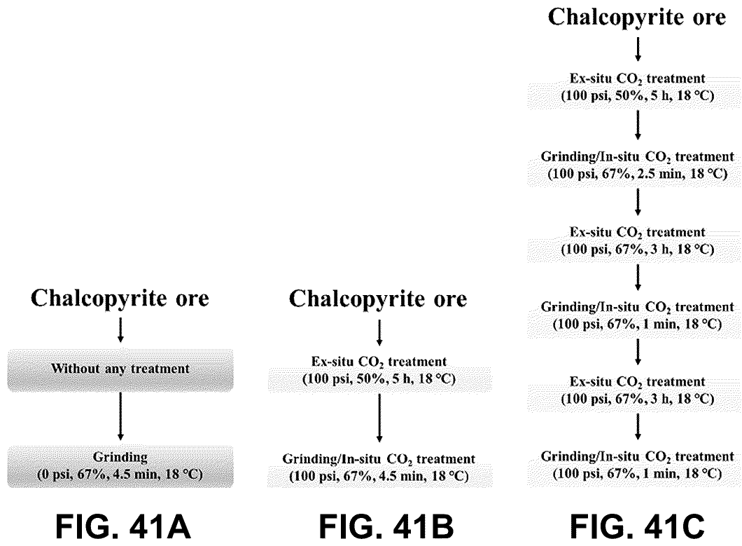

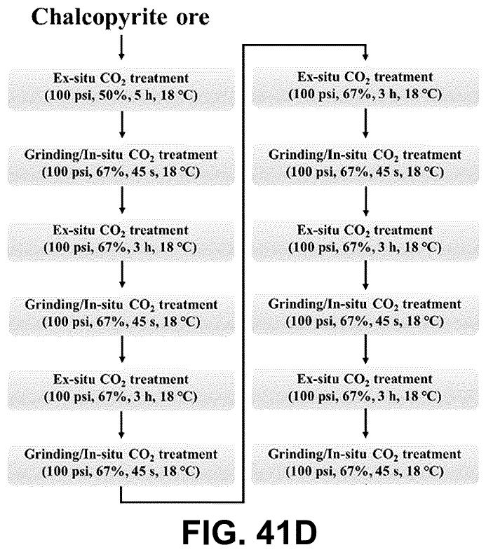

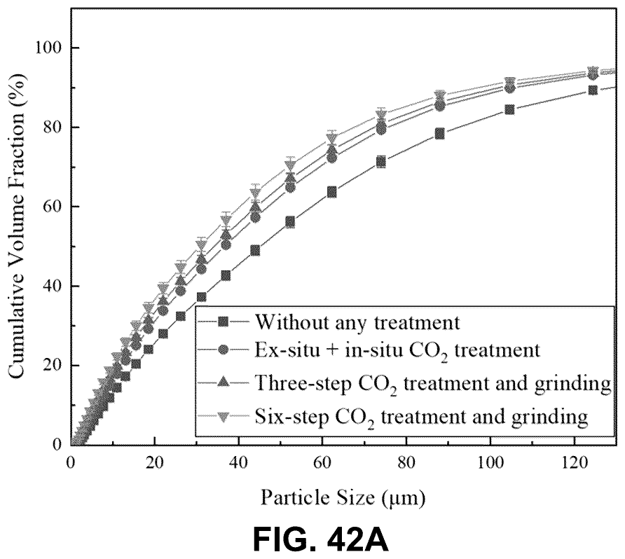

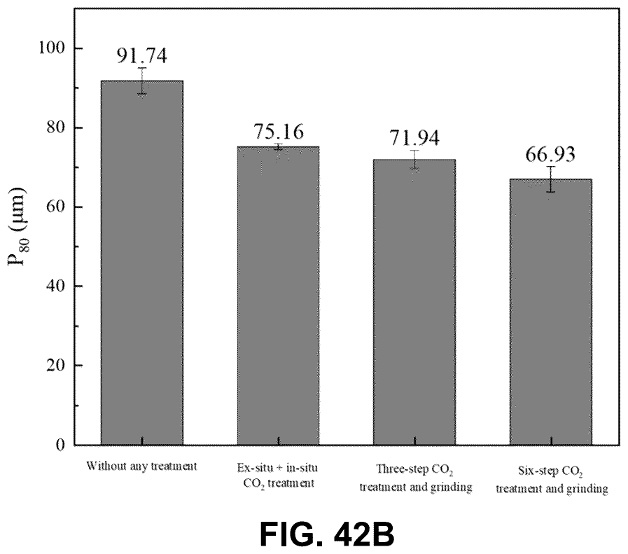

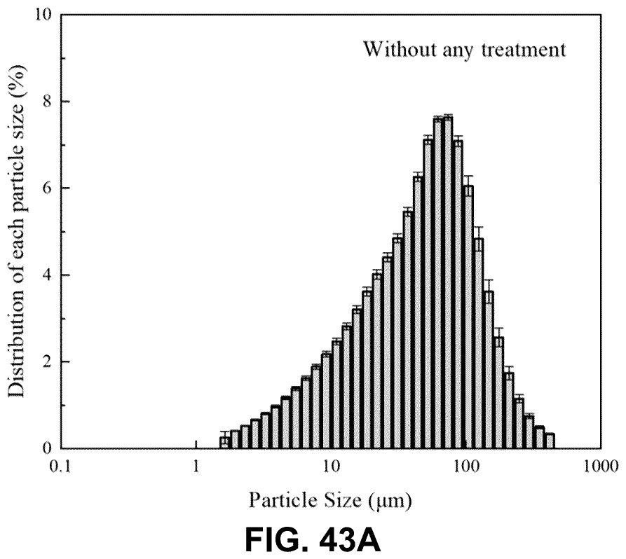

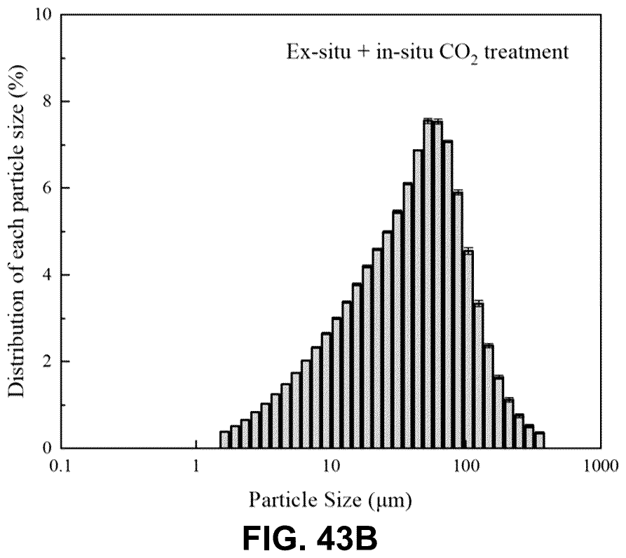

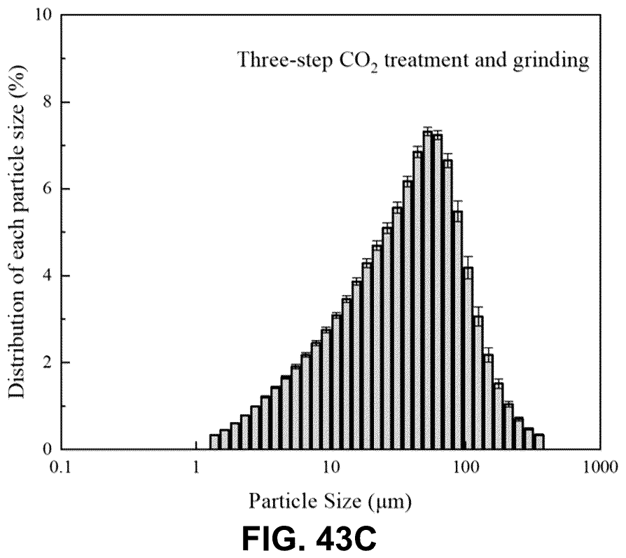

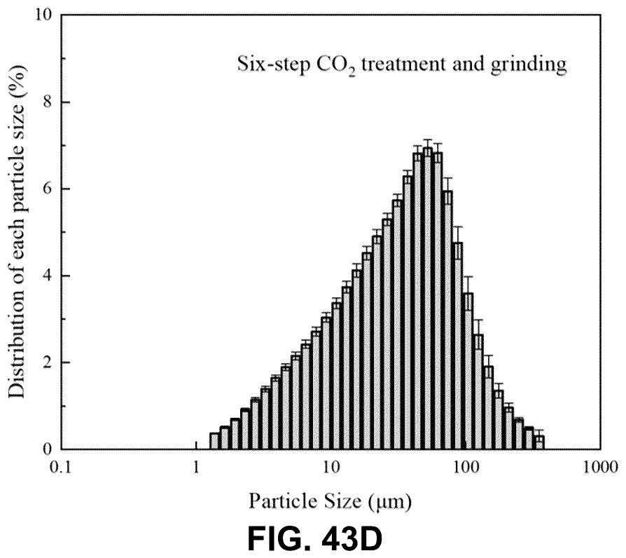

Similarly, for chalcopyrite, comparisons were made without any treatment and ex-situ+in-situ CO₂ treatment to evaluate the grinding aid effect of the stepwise treatment. The test conditions are shown in FIGS. 41A-41D. As shown in FIGS. 42A-42B, without any treatment, the P₈₀ of the full particle size of the chalcopyrite is 91.74 μm. After the ex-situ+in-situ CO₂ treatment, the P₈₀ drops to 75.16 μm. After conducting the CO₂ treatment and grinding in three steps and six steps, the P₈₀ further decreases to 71.94 μm and 66.93 μm, respectively. This indicates that the stepwise treatment allows CO₂ to react with more mineral surfaces, which can allow for further improvement of the grindability of chalcopyrite. The detailed distribution of each particle size is shown in FIGS. 43A-43D.

Bond work index measurement. The empirical formula for Bond's theory of comminution:

$$E = {W}_{i} ( \frac{10}{\sqrt{{p}_{80}}} - \frac{10}{\sqrt{{F}_{80}}} )$$

In this equation, E is the energy consumed to crush a short ton of feed with a particle size of F₈₀ to a product with a particle size of P₈₀, KW·h/ton; Wᵢ is the Bond work index, which is the energy required in k·Wh per ton to crush material from a “theoretically infinite particle size” to a size such that 80% passes through a 100 μm wide sieve (or 65% passes through a 200 mesh wide sieve), kW·h/ton; F₈₀ is the width of the square sieve hole through which 80% of the feed can pass, μm; P₈₀ is the width of the square sieve hole through which 80% of the grinding product can pass, μm.

If the work index Wᵢᵣ of the standard ore is known, the work index Wᵢᵤ of the ore to be tested can be determined through the grinding test. Since the energy consumed by grinding two ores of the same weight with the same mill under the same conditions should be equal, the following formula can be obtained:

$${W}_{i r} ( \frac{10}{\sqrt{{p}_{80 r}}} - \frac{10}{\sqrt{{F}_{80 r}}} ) = {W}_{i u} ( \frac{10}{\sqrt{{p}_{80 u}}} - \frac{10}{\sqrt{{F}_{80 u}}} )$$

Rearranged, this gives us the formula:

$${W}_{i u} = {W}_{i r} ( \frac{10}{\sqrt{{p}_{80 r}}} - \frac{10}{\sqrt{{F}_{80 r}}} ) {( \frac{10}{\sqrt{{p}_{80 u}}} - \frac{10}{\sqrt{{F}_{80 u}}} )}^{- 1}$$

Therefore, by combining the distributions of the grinding products, the Bond work indexes of the ore under different treatment conditions can be calculated, as shown in Table 2. The results show that after ex-situ+in-situ CO₂ treatment, the work index of bastnaesite ore dropped from 6.96 KW·h/t to 6.11 KW·h/t, a decrease of 12.21%. After three-step and six-step treatment and grinding, the work index of bastnaesite ore was further reduced to 5.93 KW·h/t and 5.47 KW·h/t, respectively, a decrease of 14.80% and 21.41%, respectively. After ex-site+in-situ CO₂ treatment, the work index of chalcopyrite ore decreased from 11.72 KW·h/t to 9.87 KW·h/t, a decrease of 15.78%; after three-step and six-step treatment and grinding, the work index of chalcopyrite ore further decreased to 9.51 KW·h/t and 8.97 KW·h/t, a decrease of 18.86% and 23.46%, respectively.

TABLE 2
Bond work indexes of the ore under different treatment conditions.

| | | Energy | | Bond work | |
|---|---|---|---|---|---|
| | Treatment | consumption | P₈₀ | index | Reduction |
| | Process | (KW · h) | (μm) | (KW · h/t) | (%) |
| Bastnaesite | 1 | — | 455.17 | — | — |
| | 2 | 0.016 | 87.01 | 6.96* | — |
| | 3 | 0.016 | 74.81 | 6.11 | 12.21 |
| | 4 | 0.07 + 0.04 + 0.05 | 72.27 | 5.93 | 14.80 |
| | 5 | 0.003 + 0.003 + 0.002 + | 65.49 | 5.47 | 21.41 |
| | | 0.003 + 0.002 + 0.003 | | | |
| Chalcopyrite | 1 | — | 468.67 | — | — |
| | 2 | 0.020 | 91.74 | 11.72* | — |
| | 3 | 0.020 | 75.16 | 9.87 | 15.78 |
| | 4 | 0.012 + 0.04 + 0.04 | 71.94 | 9.51 | 18.86 |
| | 5 | 0.003 + 0.004 + 0.003 + | 66.93 | 8.97 | 23.46 |
| | | 0.003 + 0.004 + 0.003 | | | |

¹ raw ore
² without any treatment
³ ex-situ + in-situ CO₂ treatment
⁴ three-step treatment
⁵ six-step treatment
*Bond work index of raw ore that has not undergone CO₂ treatment

It should be emphasized that the above-described embodiments of the present disclosure are merely possible examples of implementations set forth for a clear understanding of the principles of the disclosure. Many variations and modifications may be made to the above-described aspects. All such modifications and variations are intended to be included herein within the scope of this disclosure and protected by the following claims.

What is claimed:

1. A method, comprising:
adding a slurry to a container, wherein the slurry comprises water and an ore sample;
injecting CO₂ into the container until a target partial pressure of CO₂ is reached; and
heating the mixture of the slurry and CO₂, thereby forming a treated slurry.

2. The method of claim 1, wherein the concentration of the ore sample in the slurry is about 20% to about 99%.

3. The method of claim 1, wherein the slurry further comprises sodium bicarbonate.

4. The method of claim 1, wherein the target partial pressure of CO₂ is about 100 psi to about 1200 psi.

5. The method of any one of claim 1, wherein the mixture is heated to a temperature of about 18° C. to about 185° C. for about 0.5 hours to about 8 hours.

6. The method of any one of claim 1, further comprising:
drying the treated slurry, thereby forming a concentrated slurry; and
grinding the concentrated slurry.

7. The method of claim 6, wherein the concentrated slurry comprises ore particles, and further comprising grinding the concentrated slurry until the ore particles have a particle size of about 0.01 mm to about 0.15 mm.

8. A method, comprising:
adding a slurry to a sealable container, wherein the slurry comprises water and an ore sample;
injecting CO₂ into the sealable container until a target partial pressure of CO₂ is reached; and
grinding the slurry, thereby forming a ground slurry.

9. The method of claim 8, wherein the concentration of the ore sample in the slurry is about 30% to about 99%.

10. The method of any claim 8, wherein the slurry further comprises sodium bicarbonate.

11. The method of any claim 8, wherein the partial pressure of CO₂ is about 1 psi to about 100 psi.

12. The method of claim 8, wherein the slurry comprises ore particles and wherein the slurry is ground until the ore particles have a particle size of about 0.01 mm to about 0.15 mm.

13. A method, comprising:
performing an ex-situ treatment on a slurry, wherein the slurry comprises water and an ore sample, the ex-situ treatment comprising:
adding the slurry to a first container;
injecting CO₂ into the first container until a first target partial pressure of CO₂ is reached; and
heating the mixture of the slurry and CO₂, thereby forming a treated slurry; and
performing an in-situ treatment on the treated slurry, the in-situ treatment comprising:
adding the treated slurry to a second container;
injecting CO₂ into the second container until a second target partial pressure of CO₂ is reached; and
grinding the treated slurry, thereby forming a ground slurry.

14. The method of claim 13, wherein the concentration of the ore sample in the treated slurry is about 50% to about 99%.

15. The method of claim 13, further comprising repeating the ex-situ treatment and the in-situ treatment from 2 to 10 times, wherein the ground slurry from the previous in-situ treatment is used as the slurry for the ex-situ treatment.

16. The method of claim 13, wherein the concentration of the ore sample in the slurry is about 20% to about 99%.

17. The method of claim 13, wherein the slurry further comprises sodium bicarbonate.

18. The method of claim 13, wherein the first target partial pressure of CO₂ is about 100 psi to about 1200 psi.

19. The method of claim 13, wherein the second target partial pressure of CO₂ is about 1 psi to about 100 psi.

20. The method of claim 13, wherein the mixture is heated to a temperature of about 18° C. to about 185° C. for about 0.5 hours to about 8 hours.
